(19) United States
(12) Patent Application Publication
(10) Pub. No.: US 2010/0056413 A1
(43) Pub. Date: Mar. 4, 2010

(54) HIGH-TEMPERATURE CLEANING SYSTEM, ASSOCIATED SUBSTRATES, AND ASSOCIATED METHODS

(76) Inventors: David Ray Harry, JR., Oak Ridge, NC (US); Tami Jo Tadrowski, Hillsborough, NC (US); Karen Odom Rigley, Greensboro, NC (US); Danielle Elise Jessee, Winston-Salem, NC (US)

Correspondence Address: ECOLAB INC., MAIL STOP ESC-F7, 655 LONE OAK DRIVE, EAGAN, MN, 55121, US

(21) Appl. No.: 12/203,998

(22) Filed: Sep. 4, 2008

(51) Int. Cl. C11D 7/60; A47L 17/00

(52) U.S. Cl. 510/197; 15/210.1

(57) ABSTRACT

A cleaning system adapted for cleaning a surface while maintaining the surface at a temperature up to the operating temperature of the surface is disclosed. The cleaning system includes a cleaning composition and a substrate. The cleaning composition is adapted to withstand a temperature up to the operating temperature of the surface. Also, the cleaning composition includes one or more solvents, one or more surfactants, and one or more alkalinity sources or one or more acidity sources. The substrate includes a material and is adapted to communicate the cleaning composition to the soiled surface. Also, the substrate is adapted to withstand a temperature up to the operating temperature of the surface and the cleaning composition at least during the communication of the cleaning composition.

Aspects of embodiments and embodiments of the present invention relate to a high-temperature cleaning system, associated substrates, and associated methods.

### BACKGROUND

Numerous cleaning systems are known for the cleaning of hard surfaces such as griddles. One type of cleaning system that has gained a presence over the years due to its ubiquitousness despite requiring long, hard work is a griddle cleaning kit that comprises one or more cleaning implements, a liquid delivery system for delivering a griddle cleaning composition, and one or more cleaning substrates. Some of the cleaning implements typically have a handle, which may be telescoping, that is connected to a head. One cleaning implement is a griddle pad holder having a head adapted for removably attaching a cleaning substrate such as a griddle pad. This griddle pad may be augmented with a griddle screen when there is a need to clean a heavily charred griddle. Another cleaning implement is a griddle squeegee having a head adapted for squeegeeing. In use, a cleaning composition is delivered to the hard surface. The griddle pad holder head with the griddle pad or griddle pad augmented with the griddle screen is scrubbed through the cleaning composition and over the hard surface of the griddle in order to clean the surface. Then, the griddle squeegee is used to wipe away dirt and excess cleaning solution.

It would therefore be desirable to provide an easy-to-use cleaning system not requiring long, hard work.

### SUMMARY

Aspects of embodiments and embodiments of the present invention meet these and other needs by providing, without limitation, a cleaning system, a substrate usable in a cleaning system, a method of using a substrate, a method of making a cleaning system, and a method of using a cleaning system. Advantageously, such a cleaning system is adapted for cleaning a surface while maintaining the surface at a temperature up to the operating temperature of the surface. The cleaning system includes a cleaning composition and a substrate. The cleaning composition is adapted to withstand a temperature up to the operating temperature of the surface. Also, the cleaning composition includes one or more solvents, one or more surfactants, and one or more alkalinity sources or one or more acidity sources. The substrate includes a material and is adapted to communicate the cleaning composition to the soiled surface. Also, the substrate is adapted to withstand a temperature up to the operating temperature of the surface and the cleaning composition at least during the communication of the cleaning composition.

In aspects of embodiments, the substrate may be adapted to withstand a temperature up to the operating temperature during a removal of the soil from the surface. In other aspects of embodiments, the cleaning composition comprises an effective amount for soil removal and at least partially impregnates the substrate. In still other aspects of embodiments, the operating temperature of the surface may be up to about 263° C. (505° F.).

In yet other aspects of embodiments, the cleaning system may further include packaging adapted to enclose and/or protect the cleaning composition and the substrate. Such packaging may be adapted to facilitate a sale, distribution, storage, and/or use of a cleaning system. To that end in an aspect of an embodiment, the packaging may be adapted to facilitate separately enclosing and/or separately protecting the cleaning composition and/or the substrate. In such an aspect of an embodiment, the packaging may be adapted to further include a mechanism for effecting an impregnation of the substrate with an effective amount of cleaning composition for soil removal.

In yet other aspects of embodiments relating to a cleaning composition including one or more alkalinity sources (basic cleaning composition), in addition to one or more solvents, one or more surfactants, and one or more alkalinity sources, the basic cleaning composition further may include any one of one or more builders, one or more buffers, one or more viscosity control agents, one or more foam control agents, one or more hydrotropes, or any combination of any two or more of the preceding. In aspects relating to a cleaning composition including one or more acidity sources (acidic cleaning composition), in addition to one or more solvents, one or more surfactants, and one or more acidity sources, the acidic cleaning composition further may include any one of one or more builders, one or more buffers, one or more viscosity control agents, one or more foam control agents, one or more hydrotropes, or any combination of any two or more of the preceding.

In yet other aspects of embodiments, the substrate includes a polymeric material. In some of these aspects, the polymeric material may be or include any one of a woven fabric, knit fabric, nonwoven fabric, sheet, or any combination of any two or more of the preceding. In other of these aspects, the polymeric material may be or include a natural fiber, a manufactured fiber, or a natural fiber and a manufactured fiber. In other aspects, the polymeric material may be or include any one of a polyacrylonitrile (PAN), carbon fiber (e.g., including the TENAX® family of products and PYROMEX® family of products from Toho Tenax Europe GmbH, Wuppertal, Germany), polyester, rayon, spandex, polyolefin (e.g., including polyethylene {e.g., including DYNEEMA® family of products from DSM Dyneema LLC, Stanley, N.C.; SPECTRA® family of products from Honeywell Specialty Materials, Morristown N.J.}), polystyrene, polyvinyl, polyester, polyamide including aromatic polyamide (e.g., including TWARON® family of products from Teijin Aramid BV, Arnhem, Netherlands; KEVLAR® family of products from E.I. du Pont de Nemours and Co., Wilmington, Del.; TECHNORA®αfamily of products from Teijin Aramid BV, Arnhem, Netherlands; NOMEX® family of products from E.I. du Pont de Nemours and Co., Wilmington, Del.), phenolic, polyurethane (e.g., including ZYLON® family of products from Toyobo Co., LTD., Osaka, Japan), polyimide, polyanhydrides, polycarbonate, polyketone, polysulfone, fluoropolymer (e.g., including GORE™ expanded PTFE (ePTFE) family of products from W. L. Gore & Associates, Inc., Newark, Del.), structural polysaccharide (e.g., including coir, cotton, flax, hemp, jute, manila, piña, raffia, ramie, sisal, a modified version of any of the preceding {e.g., a modified cellulose}, . . . the like, or any combination of any two or more of the preceding), a copolymer of any two or more of the preceding, a microfiber of any two or more of the preceding, a conjugate fiber of any two or more of the preceding, a blend of any two or more of the preceding, or any combination of any two or more of the preceding.

In still yet other aspects of embodiments relating to the substrate, the polymeric material may be selected from among polymeric materials having a variety of thermal properties including one of decomposition temperature (Td), glass transition temperature (Tg), melting point (Tm), or any combination of any two or more of the preceding. In some aspects, a decomposition temperature (Td) may be a temperature of at least about 120° C. (248° F.), in an alternative aspect at least about 180° C. (356° F.), and in a further alternative aspect at least about 450° C. (842° F.). In other aspects, a glass transition temperature (Tg) may be a temperature of at least about −120° C. (−184° F.), in an alternative aspect at least about −30° C. (−22° F.), in another alternative aspect at least about 150° C. (302° F.), and in still yet another alternative aspect at least about 260° C. (500° F.). In yet other aspects, a melting point (Tm) may be a temperature of at least about 150° C. (302° F.), in an alternative aspect at least about 260° C. (500° F.), in another alternative aspect at least about 288° C. (550° F.), and in still yet another alternative aspect at least about 315° C. (600° F.).

In still yet other aspects of embodiments relating to the cleaning system, the substrate includes a length, a width, and a thickness. In some aspects, the length and width are substantially greater than the thickness, thereby defining a first substrate surface and a second substrate surface being opposite the first substrate surface with the thickness being therebetween. In some aspects, one of the first substrate surface and the second substrate surface is adapted for conformable communication with the soiled surface. In yet other aspects, one of the first substrate surface and a second substrate surface further comprises a layer adapted to be substantially impermeable to the cleaning composition. In such other aspects, the substantially impermeable layer may be or include one of a metal, a polymer, or a metal and a polymer. Nonlimiting examples of a substantially impermeable layer include a foil, a film, a coating, . . . the like, or any combination of any two or more of the preceding. In alternative aspects, the first substrate surface and the second substrate surface may be adapted to be permeable. In still yet other aspects, the first substrate surface includes a first substrate material, the second substrate surface includes a second substrate material, and the substrate further may include a third substrate material between the first substrate material and the second substrate material. In such other aspects, one or more of the first substrate material and the second substrate material may be adapted to communicate the cleaning composition to the surface upon contact with the surface while the third substrate material may be adapted for storing the cleaning composition prior to communicating the substrate with the surface. It will be appreciated that in such other aspects, one or more of the first substrate material and the second substrate material may be different from the third substrate material. Further, it will be appreciated that in such other aspects, the first substrate material, the second substrate material, and the third substrate material may include or be substantially the same polymeric material or substantially different polymeric materials as may be appropriate.

In aspects of embodiments relating to using the cleaning system, a surface to be cleaned may be maintained at any temperature up to the operating temperature of the surface. In some aspects, such temperature may be up to about 263° C. (505° F.). In other aspects, a substrate may be contacted with the soiled surface while the surface is cooling from up to the operating temperature. In still yet other aspects, the method further may include communicating one or more acid chemistries capable of brightening a surface to the surface. In such aspects, applicants contemplate a variety of alternatives including, without limitation, the one or more acid chemistries capable of brightening a surface being communicated to the surface: (a) with the substrate as part of the cleaning composition; and/or (b) via the substrate to the surface while the substrate remains in contact with surface to augment the cleaning composition; and/or (c) directly after the substrate has been removed; and/or (d) directly after removal of (i) the substrate and any residual cleaning composition and/or (ii) any residual mixture resulting from an interaction of a cleaning composition and a soil of the surface and/or (iii) any residual soil.

Accordingly, aspects of embodiments and embodiments of the present invention are directed to a cleaning system for cleaning a surface while maintaining the surface up to the operating temperature of the surface. The cleaning system includes a cleaning composition and a substrate. The cleaning composition is adapted to withstand a temperature up to the operating temperature of the surface. Also, the cleaning composition includes one or more solvents, one or more surfactants, and one or more alkalinity sources or one or more acidity sources. The substrate includes a material and is adapted to communicate the cleaning composition to the soiled surface. Also, the substrate is adapted to withstand a temperature up to the operating temperature of the surface and the cleaning composition at least during the communication of the cleaning composition. In aspects of embodiments, the substrate may be adapted to withstand a temperature up to the operating temperature during a removal of the soil from the surface.

Other aspects of embodiments and embodiments of the present invention are directed to a substrate usable in a cleaning system for cleaning a surface while maintaining the surface up to the operating temperature of the surface. The substrate is adapted to communicate a cleaning composition to the soiled surface. The substrate includes a polymeric material and is adapted to be compatible with the cleaning composition at least during the communication of the cleaning composition to the soiled surface. In turn, the substrate is adapted to communicate the cleaning composition to the surface to facilitate a selective removal of the soil from the surface. As with the cleaning composition, the substrate is adapted to withstand a temperature up to the operating temperature at least during the communication of the cleaning composition to the soiled surface. In aspects of embodiments, the substrate is adapted to withstand a temperature up to the operating temperature during a removal of the soil from the surface.

And other aspects of embodiments and embodiments of the present invention are directed to a method of using a substrate for cleaning a surface while maintaining the surface up to the operating temperature of the surface. The method includes selecting a substrate, at least partially impregnating the substrate with a cleaning composition, and communicating the at least partially impregnated substrate with at least a portion of the soiled surface. The substrate is selected from among one or more polymeric materials. Also, the substrate is adapted to communicate a cleaning composition to the soiled surface. In turn, the cleaning composition is adapted to withstand a temperature up to the operating temperature of the surface and to be capable of causing a selective removal of soil from the surface. Further, the substrate is adapted to withstand a temperature up to the operating temperature of the surface and the cleaning composition at least during the communication of the cleaning composition to the soiled surface. The at least partial impregnation of the substrate with the cleaning composition involves impregnating an amount sufficient to be capable of causing the selective removal of soil from the surface. As to the communicating of the at least partially impregnated substrate with at least a portion of the soiled surface, it proceeds while maintaining the surface up to the operating temperature of the surface and for a time sufficient to be capable of causing selective removal of soil from the surface without the necessity of mechanical action. In aspects of embodiments, the substrate is adapted to withstand a temperature up to the operating temperature during a removal of the soil from the surface.

Still other aspects of embodiments and embodiments of the present invention are directed to a method for cleaning a soiled surface while maintaining the surface up to the operating temperature of the surface. The method includes the steps of contacting a cleaning system including a cleaning composition and a substrate to the soiled surface, maintaining the substrate of the cleaning system in contact with the soiled surface, removing the substrate of the cleaning system from the surface, and removing any residual mixture from the surface. The contacting of the cleaning system to the soiled surface occurs while maintaining the surface up to the operating temperature of the surface. The cleaning composition is adapted to withstand a temperature up to the operating temperature of the surface and includes one or more solvents, one or more surfactants, and one or more alkalinity sources or one or more acidity sources. The substrate includes a material and is adapted to communicate the cleaning composition to the soiled surface. Also, the substrate is adapted to withstand a temperature up to the operating temperature and the cleaning composition at least during the communication of the cleaning composition. The maintaining of the substrate of the cleaning system in contact with the soiled surface occurs for at least a time sufficient to be capable of causing the cleaning composition to interact with the soil of the soiled surface to create a mixture. Any residual mixture is removed from the surface thereby cleaning of the surface. In aspects of embodiments, the substrate is adapted to withstand a temperature up to the operating temperature during a removal of the soil from the surface.

Still yet other aspects of embodiments and embodiments of the present invention are directed to a method of making a cleaning system for cleaning a soiled surface while maintaining the surface up to the operating temperature of the surface. The method includes the steps of providing a cleaning composition and providing a substrate. The cleaning composition is adapted to withstand a temperature up to the operating temperature of the surface. Also, the cleaning composition includes one or more solvents, one or more surfactants, and one or more alkalinity sources or one or more acidity sources. The substrate includes a material and adapted to communicate the cleaning composition to the soiled surface. Also, the substrate adapted to withstand a temperature up to the operating temperature and the cleaning composition at least during the communication of the cleaning composition. In aspects of embodiments, the substrate is adapted to withstand a temperature up to the operating temperature during a removal of the soil from the surface.

Numerous other aspects of embodiments, embodiments, features, and advantages of the present invention will appear from the following detailed description and the accompanying drawings. In the description and/or the accompanying drawings, reference is made to exemplary aspects of embodiments and/or embodiments of the invention. Such aspects of embodiments and/or embodiments do not represent the full scope of the invention. Reference should therefore be made to the claims herein for interpreting the full scope of the invention. In the interest of brevity and conciseness, any ranges of values set forth in this specification contemplate all values within the range and are to be construed as support for claims reciting any sub-ranges having endpoints which are real number values within the specified range in question. By way of a hypothetical illustrative example, a disclosure in this specification of a range of from 1 to 5 shall be considered to support claims to any of the following ranges: 1-5; 1-4; 1-3; 1-2; 2-5; 2-4; 2-3; 3-5; 3-4; and 4-5.

These and other aspects, advantages, and salient features of the present invention will become apparent from the following detailed description, the accompanying drawings, and the appended claims.

### BRIEF DESCRIPTION OF DRAWINGS

FIG. 1 is an isometric schematic drawing illustrating a use of a cleaning system including a substrate capable of cleaning a soiled surface while maintaining the surface up to the operating temperature of the surface constructed according to an aspect of an embodiment of the present invention;

FIG. 2 is an isometric schematic drawing illustrating a cleaning system in packaging constructed according to an aspect of an embodiment of the present invention;

FIG. 3 is an isometric schematic drawing illustrating a use of a cleaning system including a substrate including a substantially impermeable layer constructed according to an aspect of an embodiment of the present invention;

FIG. 4 is a cross-sectional schematic illustrating a cleaning system in packaging constructed according to an aspect of an embodiment of the present invention;

FIG. 5 is a cross-sectional schematic illustrating a cleaning system in packaging constructed to separate the cleaning composition and the substrate according to an aspect of an embodiment of the present invention;

FIG. 6 is an isometric schematic drawing illustrating a cleaning system in packaging including the cleaning composition separated from the substrate and including a mechanism for effecting an impregnation of the substrate with the cleaning composition constructed according to an aspect of an embodiment of the present invention; and

FIG. 7 is a cross-sectional schematic illustrating a cleaning system in packaging including a substrate including a first, second, and third material constructed according to an aspect of an embodiment of the present invention.

### DESCRIPTION

In the following description, like reference characters designate like or corresponding parts throughout the several views. Also in the following description, it is to be understood that such terms as “forward,” “rearward,” “left,” “right,” “upwardly,” “downwardly,” and the like are words of convenience and are not to be construed as limiting terms.

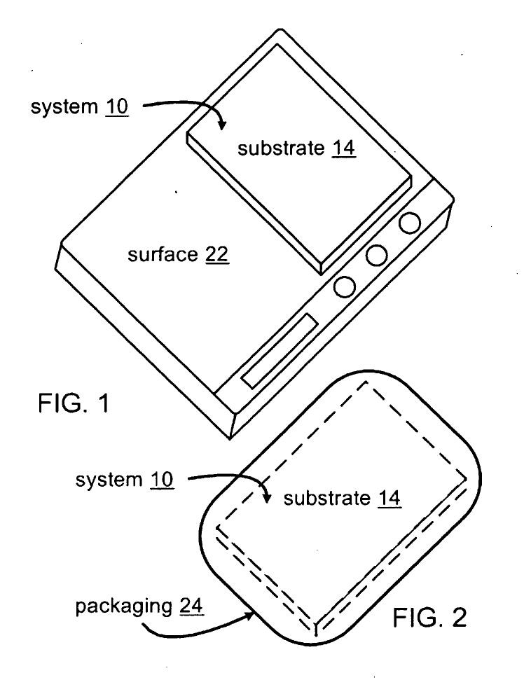

Referring now to the drawings in general, and FIGS. 1 through 7 in particular, it will be understood that the illustrations are for the purpose of describing one or more aspects of embodiments and/or embodiments of the invention and are not intended to limit the invention thereto. FIGS. 1, 2, 3, 4, 5, 6, and 7 schematically depict a cleaning system 10 adapted for cleaning a surface 22 while maintaining the surface 22 at a temperature up to the operating temperature of the surface 22. The cleaning system 10 includes a cleaning composition 12 and a substrate 14. The cleaning composition 12 is adapted to withstand a temperature up to the operating temperature of the surface 22. Also, the cleaning composition 12 includes one or more solvents 16, one or more surfactants 20, and one or more alkalinity sources 18, 18ⁿ or one or more acidity sources 8, 8ⁿ. The substrate 14 includes a material and is adapted to communicate the cleaning composition 12 to the soiled surface 22′. Also, the substrate 14 is adapted to withstand a temperature up to the operating temperature of the surface 22 and the cleaning composition 12 at least during the communication of the cleaning composition. In aspects of embodiments, the substrate 14 may be adapted to withstand a temperature up to the operating temperature during a removal of the soil from the surface 22. In other aspects of embodiments, the cleaning composition 12 comprises an effective amount for soil removal and at least partially impregnates the substrate 14. In still other aspects of embodiments, the operating temperature of the surface 22 may be up to about 263° C. (505° F.).

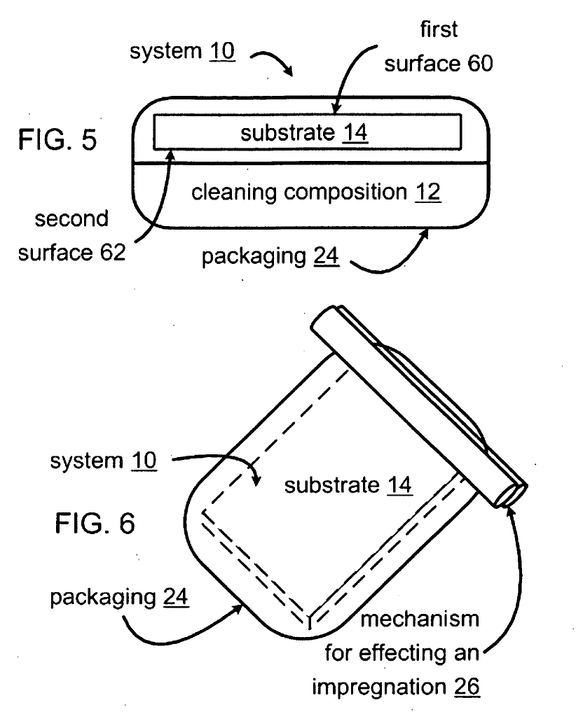

Turning to FIGS. 2, 4, 5, 6, and 7, the cleaning system 10 may further include packaging 24 adapted to enclose and/or protect the cleaning composition 12 and the substrate 14. Such packaging 24 may be adapted to facilitate a sale, distribution, storage, and/or use of a cleaning system 10. As shown in FIGS. 5 and 6, the packaging 24 may be adapted to facilitate separately enclosing and/or separately protecting the cleaning composition 12 and the substrate 14. As shown in FIG. 6, the packaging 24 may be adapted to further include a mechanism for effecting an impregnation 26 of the substrate 14 with the cleaning composition 12.

In yet other aspects of embodiments, the cleaning composition 12 further may include any one of one or more builders 30, one or more hydrotropes 44, 44ⁿ, one or more viscosity control agents 34, one or more foam control agents 36, or any combination of any two or more of the preceding. In aspects relating to an acidic cleaning composition (i.e., one or more acidity sources 8, 8ⁿ), the cleaning composition 12 may include one, some, or all of the above.

### I. CLEANING COMPOSITION 12

As noted, aspects of embodiments and embodiment of the present invention relate to the cleaning compositions 12 that may include a number of components. Such components may provide desired characteristics to the resulting cleaning compositions 12 and in turn the resulting cleaning system 10. Examples of such components include one or more solvents 16, 16ⁿ, one or more surfactants 20, 20, and one or more alkalinity sources 18, 18ⁿ or one or more acidity sources 8, 8ⁿ optionally, with any one of one or more hydrotropes 44, 44ⁿ, one or more builders 30, 30ⁿ, one or more buffers 32, 32ⁿ, one or more viscosity control agents 34, 34ⁿ, one or more foam control agents 36, 36ⁿ, or any combination of any two or more of the preceding. A description of each class of component of the cleaning composition 12 follows.

A. One or More Solvents 16, 16ⁿ

Some aspects of embodiments of the present invention relate to cleaning compositions 12 and the one or more solvents 16, 16ⁿ. It will be appreciated that the one or more solvents 16, 16ⁿ are selected so as to facilitate the cleaning a soil from a soiled surface 22′ while at the same time being compatible with a composition of a substrate 14 so as to be capable of having a cleaning composition 12 delivered to the soiled surface 22′ and, optionally, so as to be capable of removing a soil/cleaning composition mix from the soiled surface 22′ to produce a clean surface 22. To that end, suitable one or more solvents 16, 16ⁿ include, but are not limited to, water, glycols, alcohols, glycol ethers, esters, and combinations thereof. Suitable glycols include, but are not limited to, triethylene glycol (TEG), glycerin, diethylene glycol, ethylene glycol, propylene glycol, dipropylene glycol, and hexylene glycol.

The one or more solvents 16, 16ⁿ may be present in the cleaning compositions 12 in an amount of up to about 95 weight-percent (wt %) based on a total weight of the cleaning composition 12. Desirably, when present, the cleaning compositions 12 of the present invention comprise one or more solvents 16, 16ⁿ in an amount of from about 10 to about 75 wt % based on a total weight of the cleaning composition 12.

In one aspect of one embodiment, the cleaning composition 12 comprises glycerin in an amount ranging from about 13 wt % to about 75 wt % and in another aspect an amount ranging from about 40 wt % to about 68 wt % based on a total weight of the cleaning composition 12. In one aspect of another embodiment, the cleaning composition 12 comprises triethylene glycol (TEG) in an amount ranging from about 0 wt % to about 75 wt %, in another aspect an amount ranging from about 0 wt % to about 35 wt %, and in yet another aspect an amount ranging from about 0 wt % to about 15 wt % based on a total weight of the cleaning composition 12. In one aspect of yet another embodiment, the cleaning composition 12 comprises a combination of glycerin and triethylene glycol (TEG) in an amount of up to about 75 wt % of combined glycerin and triethylene glycol (TEG), in another aspect an amount ranging from about 45 to about 75 wt % of combined glycerin and triethylene glycol (TEG), and in yet another aspect an amount ranging from about 50 wt % to about 65 wt % of combined glycerin and triethylene glycol (TEG) based on a total weight of the cleaning composition 12. In one aspect of still yet another embodiment, the cleaning composition 12 comprises up to about 90 wt % water based on a total weight of the cleaning composition 12. In another aspect, water comprises an amount ranging from about 3 wt % to about 80 wt % based on a total weight of the cleaning composition 12 and in yet another aspect an amount ranging from about 15 wt % to about 55 wt % water based on a total weight of the cleaning composition 12.

Commercially available glycols suitable for use in the present invention may be obtained from a variety of vendors including, but not limited to, Dow Chemical Company (Midland, Mich.) and Atlantic Richfield Company (ARCO), a part of BP America (Houston, Tex.).

With respect to aspects of embodiments and embodiments relating to cleaning compositions 12 comprising water, soft or hard water may be used, although soft water is more desirable. As used herein, the term “soft water” refers to water containing less than about 60 ppm of calcium carbonate and magnesium carbonate. As used herein, the term “hard water” refers to water containing more than about 60 ppm of calcium carbonate and magnesium carbonate, while “very hard water” refers to water containing more than about 180 ppm of calcium carbonate and magnesium carbonate. The cleaning compositions 12 of the present invention may be formed using water available from any municipal water-treatment facility.

B. One or More Surfactants 20, 20ⁿ

Aspects of embodiments and embodiments of the present invention relate to cleaning compositions 12 and the one or more surfactants 20, 20ⁿ. Suitable surfactants include, but are not limited to, anionic surfactants, cationic surfactants, nonionic surfactants, amphoteric surfactants, or combinations thereof. It will be appreciated that such one or more surfactants 20, 20ⁿ may be, but are not limited to, natural surfactants (e.g., surfactants based on natural components such as fatty acids, coconut oil, . . . etc.). Natural surfactants include, but are not limited to, coconut-based soap solutions. Anionic surfactants include, but are not limited to, dodecyl benzene sulfonic acid and its salts, alkyl ether sulfates and salts thereof, olefin sulfonates, phosphate esters, fatty acid soaps, sulfosuccinates, and alkylaryl sulfonates. Cationic surfactants include, but are not limited to, alkoxylated cationic ammonium surfactants. Nonionic surfactants include, but are not limited to, alkoxylates or ethoxylates of alkyl phenols and alcohols, alkanolamides, and alkyl polyglycocides. Amphoteric surfactants include, but are not limited to, imidazoline derivatives, betaines, and amine oxides.

Some aspects of embodiments and embodiments of the present invention relate to cleaning compositions 12 and the one or more surfactants 20, 20ⁿ that include, but are not limited to, coconut-based soap solutions, ethoxylated alcohols containing from about 6 to about 24 carbon atoms and as many as 12 ethoxylate groups, propoxylated quat (i.e., quaternary surfactants), and combinations thereof. In aspects of one embodiment, the cleaning composition 12 comprises a coconut-based soap solution. In aspects of another embodiment, the cleaning composition 12 comprises a combination of surfactants, wherein the combination comprises two or more ethoxylated alcohols wherein each alcohol has from about 8 to about 16 carbon atoms and up to about 8 ethoxylate groups.

In one aspect of embodiments of the present invention, one or more surfactants 20, 20ⁿ may be present in an amount of up to about 80 wt % based on a total weight of the cleaning composition 12. In another aspect of embodiments, the one or more surfactants 20, 20ⁿ are present in an amount ranging from about 0.1 wt % to about 50 wt % based on a total weight of the cleaning composition 12. In yet another aspect of embodiments, the one or more surfactants 20, 20ⁿ are present in an amount ranging from about 0.5 wt % to about 30 wt % based on a total weight of the cleaning composition 12.

A number of commercially available surfactants may be used in the present invention. Suitable commercially available coconut-based soap solution surfactants include, but are not limited to, coconut-based soap solution (30%) available from Kay Chemical Company (Greensboro, N.C.); ammonium cocoate available from Chemron Corporation (Paso Robles, Calif.); Carroll 40% coconut soap available from Carroll Company (Garland, Tex.); and potassium cocoate available from Lubrizol Advanced Materials, Inc. (Cleveland, Ohio). Suitable commercially available ethoxylated alcohols having from about 8 to about 16 carbon atoms and up to about 8 ethoxylate groups include, but are not limited to, family of surfactant products sold under the trade designation SURFONIC®, available from Huntsman Chemical Company (Houston, Tex.), such as, SURFONIC® L24-3 surfactant; family of surfactant products sold under the trade designation TERGITOL™, available from Dow Chemical Company (Midland, Mich.), such as TERGITOL™ 15S-7; family of surfactant products sold under the trade designation TRITON™, available from Dow Chemical Company (Midland, Mich.), such as the TRITON™ DF series and the TRITON™ EF series. Suitable commercially available alkoxylated cationic ammonium surfactants include, but are not limited to, family of surfactant products sold under the trade designation GLENSURF™, available from the Glenn Chemical Company (St. Paul, Minn.), such as GLENSURF™ 42; family of surfactant products sold under the trade designation VARIQUAT®, available from the Evonik Degussa Corporation (Parsippany, N.J.), such as VARIQUAT® CC-42NS; and family of surfactant products sold under the trade designation EMCOL®, available from Akzo Nobel Surface Chemistry LLC (Chicago, Ill.), such as EMCOL® CC-9, EMCOL® CC-36, and EMCOL® CC42.

C. C(1) One or More Alkalinity Sources 18, 18ⁿ or

C(2) One or More Acidity Sources 8, 8ⁿ

Aspects of embodiments and embodiments of the present invention relate to cleaning compositions 12 and the one or more acidity sources 8, 8ⁿ or one or more alkalinity sources 18, 18ⁿ. The pH of the cleaning composition 12 may range from about 0 to about 14.

C(1). One or More Alkalinity Sources 18, 18ⁿ

In aspects of embodiments and embodiments of the present invention relating to cleaning compositions 12 and the one or more alkalinity sources 18, 18ⁿ, the pH of the cleaning composition 12 may be from above about 7 to about 14, in another aspect, from about 8 to about 13, and in yet another aspect, about 10 to about 12.5. Typically, when present, one or more alkalinity sources 18, 18ⁿ are present in an amount of up to about 20 wt % based on a total weight of the cleaning composition 12.

Suitable one or more alkalinity sources 18, 18ⁿ include, but are not limited to, one or more organic alkalinity sources, one or more inorganic alkalinity sources, or combinations thereof. Suitable organic alkalinity sources include, but are not limited to, strong nitrogen bases including, for example, ammonia (ammonium hydroxide), monoethanolamine, monopropanolamine, diethanolamine, dipropanolamine, triethanolamine, tripropanolamine, 2-amino-2-methyl-1-propanol (AMP), . . . the like, or combinations thereof. Suitable inorganic alkalinity sources include, but are not limited to, alkali metal hydroxides (e.g., sodium hydroxide, potassium hydroxide, lithium hydroxide, . . . the like, or combinations thereof), alkali metal carbonates (e.g., sodium carbonate, potassium carbonate, sodium bicarbonate, potassium bicarbonate, sodium sesquicarbonate, potassium sesquicarbonate, . . . the like, or combinations thereof), alkali metal borates (e.g., sodium borate, potassium borate, . . . the like, or combinations thereof), alkali metal oxides (e.g., sodium oxide, potassium oxide, . . . the like, or combinations thereof), . . . the like, or combinations thereof.

As to an amount of one or more alkalinity sources 18, 18ⁿ, in one aspect it may be that amount that is sufficient to provide free alkalinity (expressed as Na₂O) of greater than about 0.5 wt %, based on the total weight of the cleaner concentrate, and a total alkalinity (expressed as expressed as Na₂O) of greater than about 6.1 wt %, based on the total weight of the cleaner concentrate.

A number of commercially available alkalinity sources may be suitable for use in aspects of embodiments or embodiments of the present invention. Commercially available alkalinity sources may be obtained from a variety of vendors including, but not limited to, PPG Industries (Pittsburgh, Pa.), Dow Chemical Company (Midland, Mich.), and Angus Chemical Company (Buffalo Grove, Ill.). For example, suitable commercially available amino alcohols include, but are not limited to, AMP-95™ primary amino alcohol (2-Amino-2-methyl-1-propanol+5% water) and AMP-90™ amino alcohol (2-Amino-2-methyl-1-propanol+10% water) available from Angus Chemical Company (Buffalo Grove, Ill.). Suitable commercially available caustic soda include, but are not limited to, liquid caustic soda (sodium hydroxide) as 50% (alkali equivalent, wt % Na₂O about 39%) and 73% (alkali equivalent, wt % Na₂O about 57%) solutions in water available from PPG Industries. (Pittsburgh, Pa.). Suitable commercially available alkyl alkanolamines include, but are not limited to, monoethanolamine (HOCH₂CH₂NH₂) as MEA grade, MEA LFG grade (an 85% solution of monoethanolamine with 15% water), and MEA ICF grade available from Dow Chemical Company (Midland, Mich.).

C(2). One or More Acidity Sources 8, 8ⁿ

In aspects of embodiments and embodiments of the present invention relating to cleaning compositions 12 and the one or more acidity sources 8, 8ⁿ, the pH of the cleaning composition 12 may be from about 0 to about 7, in another aspect, from about 1 to about 6, and in yet another aspect, about 3 to about 5.5. Typically, when present, one or more acidity sources 8, 8ⁿ are present in an amount of up to about 20 wt % based on a total weight of the cleaning composition 12.

Suitable one or more acidity sources 8, 8ⁿ include, but are not limited to, a weak acid or strong acid. To that end, it will be appreciated that one or more acidity sources 8, 8ⁿ include a composition that can be added to an aqueous system and result in a pH less than 7. Strong acids that can be used in the cleaning compositions 12 include acids that substantially dissociate in an aqueous solution such as hydrochloric acid, sulfuric acid, trichloroacetic acid, trifluoroacetic acid, linear alkylbenzene sulfonic acid (LAS), . . . the like, or combinations thereof. “Weak” organic and inorganic acids used in the invention are acidic components in which the first dissociation step of a proton from the acid moiety does not proceed essentially to completion when the acid is dissolved in water at ambient temperatures at a concentration within the range useful to form the present compositions. Such inorganic acids are also referred to as weak electrolytes as the term is used in Text Book of Quantitative Inorganic Analysis, I. M. Koltoff et al. as the McMillan Co., Third Edition, 1952 at pp. 34-37. Most common commercially available weak organic and inorganic acids can be used in the invention. Examples of weak inorganic acids include phosphoric acid, sulfamic acid, . . . the like, or combinations thereof. Useful weak organic acids include formic acid (methanoic acid), acetic acid (ethanoic acid), propionic acid (propanoic acid), butyric acid (butanoic acid) valeric acid (pentanoic acid), caproic acid (hexanoic acid), enanthic acid (heptanoic acid), caprylic acid (octanoic acid), pelargonic acid (nonanoic acid) capric acid (decanoic acid), lauric acid (dodecanoic acid), myristic acid (tetradecanoic acid), palmitic acid (hexadecanoic acid), stearic acid (octadecanoic acid), oleic acid (cis-9-octadecenoic acid), linoleic acid (cis,cis-9,12-octadecadienoic acid), oxalic acid, malonic acid, succinic acid, maleic acid, fumaric acid, glutaric acid, adipic acid, pimelic acid, suberic acid, azelaic acid, sebacic acid, benzoic acid, carbonic acid, glycolic acid (hydroxyacetic acid), lactic acid, malic acid, tartaric acid, citric acid, . . . the like, or combinations thereof. In certain aspects, mixtures of a strong acid with a weak acid or mixtures of a weak organic acid and a weak inorganic acid can result in surprisingly increased cleaning efficiency. Such acid cleaners tend to be most effective to clean basic organic and inorganic soils. The most commonly cleaned soil using acid cleaners involves the precipitation of hardness components of service water with cleaning compositions or food soils that can precipitate in the presence of calcium, magnesium, iron, manganese or other hardness components. Such soils include dairy residues, soap scum, saponified fatty acids, or other marginally soluble anionic organic species that can form a soil precipitate when contacted with divalent hardness components of surface water.

In aspects, the one or more acidity sources 8, 8ⁿ include acidulants that include organic and inorganic acids such as citric acid, lactic acid, acetic acid, glycolic acid, adipic acid, tartaric acid, succinic acid, propionic acid, maleic acid, alkane sulfonic acids, cycloalkane sulfonic acids, phosphoric acid, . . . the like, or combinations thereof.

A number of commercially available acidity sources may be suitable for use in aspects of embodiments or embodiments of the present invention. Commercially available acidity sources may be obtained from a variety of vendors including, but not limited to, A. E. Staley, owned by Tate & Lyle, PLC, (Decatur, Ill.). In aspects of embodiments, the cleaning compositions 12 contain an acidity source 8, 8ⁿ comprising a citric acid available from A. E. Staley, owned by Tate & Lyle, PLC, (Decatur, Ill.).

D. One or More Builders 30, 30ⁿ

Aspects of embodiments and embodiments of the present invention relate to cleaning compositions 12 and the one or more builders 30, 30ⁿ. Suitable builders for use in the present invention include, but are not limited to, organic compounds, inorganic compounds, or combinations thereof. In aspects of one embodiment, the builders are organic. Nonlimiting examples of organic builders include the salts or acid form of amino carboxylates, organic phosphonates, polycarboxylates, or mixtures thereof. Nonlimiting examples of organic phosphonates include amino tri(methylene phosphonate), hydroxyethylidene diphosphonate, diethylenetriamine penta-(methylenephosphonate), and ethylenediamine tetra(methylene-phosphonate). Nonlimiting examples of polycarboxylates include citric acid and it salts and derivatives, sodium glutarate, potassium succinate, polyacrylic acid and its salts and derivatives, and copolymers. Nonlimiting examples of polyamino compounds include ethylene diamine (EDTA), diethyltriaminepentaacetic acid (DTPA), hydroxyethylene diamine, and their salts and derivatives. In aspects of another embodiment, the builders are inorganic. Nonlimiting examples of inorganic builders include sodium tripolyphosphate, sodium carbonate, sodium pyrophosphate, potassium pyrophosphate, magnesium phosphate, tetramethylammonium phosphate, potassium carbonate, sodium phosphate, or combinations thereof.

In aspects of yet another embodiment, the cleaning composition 12 comprises one or more builders 30, 30ⁿ selected from iminodisuccinate, citrate, sodium bicarbonate, ethylenediamine or triamine derivatives, or mixtures thereof.

In one aspect of embodiments, when present, the one or more builders 30, 30′ may be present in an amount of up to about 60 wt % based on a total weight of the cleaning composition 12. In another aspect of embodiments, when present, the one or more builders 30, 30ⁿ are present in an amount ranging from about 10 wt % to about 40 wt % based on a total weight of the cleaning composition 12. In another aspect of embodiments, when present, the one or more builders 30, 30ⁿ are present in an amount ranging from about 20 wt % to about 30 wt % based on a total weight of the cleaning composition 12.

A number of commercially available builders may be used in the present invention. Suitable commercially available builders include, but are not limited to, sodium bicarbonate for example available from Church & Dwight Co., Inc. (Princeton, N.J.) and potassium carbonate for example available from Armand Products Company (Princeton, N.J.) or ASHTA Chemicals Inc. (Ashtabula, Ohio).

E. One or More Buffers 32, 32ⁿ

Aspects of embodiments and embodiments of the present invention relate to cleaning compositions 12 and the one or more buffers 32, 32ⁿ. An inclusion of one or more buffers 32, 32ⁿ that results in a pH other than that optimally sought for any given cleaning compositions 12 may result in a reduction or limitation of the cleaning compositions' 12 effect. For example, cleaning compositions' 12 ingredients may be sensitive to the pH in the surrounding environment. Accordingly, altering the pH of the aqueous environment to which the cleaning compositions' 12 ingredients are introduced regulates the ability of such ingredients to solublize a soil present on a surface 22.

As a result, the one or more buffers 32, 32ⁿ generally maintain the pH of the environment within which the cleaning compositions' 12 ingredients works to a pH of about 0 to about 14. As noted, in aspects of embodiments and embodiments of the present invention the pH of the cleaning composition 12 may be from about 7 to about 13, in other aspects, from about 8 to about 13, and in yet other aspects, about 10 to about 12.5. Also as noted in aspects of embodiments and embodiments of the present invention, the pH of the cleaning composition 12 may be from about 0 to about 7, in other aspects, from about 1 to about 6, and in yet other aspects, about 3 to about 5.5. Typically, when present, the one or more buffers 32, 32ⁿ are present in an amount of up to about 20 wt % based on a total weight of the cleaning composition 12.

Generally any one or more buffers 32, 32ⁿ that are capable of providing an environment of the proper pH can be used in the processing cleaning compositions 12 of the present invention. When used, one or more buffers 32, 32ⁿ may include a base and a complementary acid. Examples of a base include, without limitation, one or more of a borate (e.g., tetraborate, borax, . . . the like, or combinations thereof), bicarbonate (e.g., sodium bicarbonate, mixtures of sodium bicarbonate and sodium carbonate, . . . the like, or combinations thereof), carbonate (e.g., sodium carbonate), phosphate (e.g., disodium phosphate, monosodium phosphate, mixtures of disodium phosphate and trisodium phosphate, . . . the like, or combinations thereof), . . . the like, or combinations thereof. Examples of complementary acids include, without limitation, one or more of an alkali metal salt of an acid, alkali metal salt of an organic acid, or organic amine salt of an organic acid, such as, without limitation, sodium, potassium or triethanolamine salts of acetic acid, boric acid, citric acid, dodecyl benzene sulfonic acid (DDBSA), lactic acid, tartaric acid, . . . the like, or combinations thereof.

Generally, if pH control is desired to insure a certain activity of cleaning compositions' 12 ingredients, an appropriate type and amount of one or more buffers may be used. As to an amount of one or more buffers 32, 32ⁿ, in one aspect it may be up to about 20 wt % or more, based on the total weight of the cleaner concentrate. In another aspect, the one or more buffers may be about 0.1 wt % to about 10 wt %, based on the total weight of the cleaning compositions 12. In yet another aspect, the one or more buffers may be about 0.1 wt % to about 5 wt %, based on the total weight of the cleaning compositions 12. In still yet another aspect, an amount of one or more buffers may be about 0.1 wt % to about 1 wt %, based on the total weight of the cleaning compositions 12. One or more buffers suitable, due to their overall stability and compatibility with cleaning compositions' 12 ingredients include, without limitation, sodium bicarbonate, sodium citrate, and borax. Also, such one or more buffers one or more buffers 32, 32ⁿ are readily commercially available, for example, but are not limited to, sodium citrate from A.E. Staley Division (Decatur, Ill.) of Tate & Lyle PLC and alkali metal carbonates such as, but are not limited to, potassium carbonate 47% liquid solution (i.e., 47 wt % potassium carbonate in water) available from Ashta Chemicals (Ashtabula, Ohio).

E. One or More Viscosity Control Agents 34, 34ⁿ

Aspects of embodiments and embodiments of the present invention relate to cleaning compositions 12 and the one or more viscosity control agents 34, 34ⁿ (e.g., thickeners) in an amount of up to about 10 wt % based on a total weight of the cleaning composition 12. Suitable viscosity control agents 34, 34ⁿ include, but are not limited to, xanthan gum thickeners, acrylic polymers, polyethylene glycols, highly ethoxylated alcohol ethoxylates (e.g., having more than 12 ethylene oxide {EO} units), cellulosic polymers, and combinations thereof.

In aspects of one embodiment, the cleaning composition 12 comprises a xanthan gum thickener in an amount ranging from about 0.01 wt % to about 1 wt % based on a total weight of the cleaning composition 12. In aspects of another embodiment, the cleaning composition 12 comprises from about 0.1 wt % to about to 0.5 wt % of one or more xanthan gum thickeners based on a total weight of the cleaning composition 12.

In aspects of yet another embodiment, the cleaning composition 12 comprises one or more acrylic polymers. In one aspect, the one or more acrylic polymers comprise an amount ranging from about 0.01 wt % to about 10 wt % based on a total weight of the cleaning composition 12, in another aspect an amount ranging from about 2 wt % to about 8 wt %, and in yet another aspect an amount ranging from about 2 wt % to about 6 wt % of one or more acrylic polymers based on a total weight of the cleaning composition 12.

Commercially available viscosity control agents 34, 34ⁿ include, but are not limited to, xanthan gums sold under the trade designation KELTROL® available from CP Kelco (Wilmington, Del.), such as the KELTROL® and KELTROL® HP products. Suitable commercially available acrylic polymers include, but are not limited to, acrylic polymers sold under the trade designation ACUSOL®, available from Rohm and Haas (Glen Allen, Va.), such as ACUSOL® 820.

F. One or More Foam-Control Agents 36, 36ⁿ

According to aspects of embodiments and embodiments of the present invention relate to cleaning compositions 12 and one or more foam-control agents 36, 36ⁿ. Suitable foam-control agents 36, 36ⁿ include, but are not limited to, silicones such as polydimethyl siloxanes.

In aspects of embodiments, the cleaning compositions 12 may comprise one or more foam-control agents 36, 36ⁿ. In one aspect, one or more foam-control agents 36, 36ⁿ comprise an amount of up to about 2.5 wt % based on a total weight of the cleaning composition 12 and in another aspect ranging from about 0.01 wt % to about 2 wt % of one or more foam-control agents, based on a total weight of the cleaning composition 12. In aspects of an embodiment, the foam-control agent 36 may be present in the form of a solution, the active ingredient (e.g., the silicone component). In one aspect of this embodiment, the active ingredient comprises an amount ranging from about 1 wt % to about 5 wt % based on a total weight of the foam-control agent 36 solution. Consequently, in this aspect, the amount of active foam-control agent 36 is typically present in the cleaning composition 12 in an amount ranging from about 0.0001 wt % to about 0.40 wt % based on a total weight of the cleaning composition 12, while in another aspect in an amount ranging about 0.01 wt % to about 0.15 wt % based on a total weight of the cleaning composition 12.

Commercially available foam-control agents 36, 36ⁿ include, but are not limited to, the family of foam-control agents sold under the trade name DOW CORNING® ANTIFOAM (e.g., antifoam 1500, antifoam 1510, antifoam 1520, antifoam A, antifoam B, antifoam C, AF emulsion, H-10 emulsion, FG-10 emulsion, 1910 powder, . . . etc.) available from Dow Corning Corporation (Midland, Mich.).

G. One or More Acid Chemistries Capable of Brightening a Surface 40, 40ⁿ

According to aspects of embodiments and embodiments of the present invention, when the cleaning compositions 12 includes one or more alkalinity sources 18, 18ⁿ, it may be subsequently supplemented (or augmented) by one or more acid chemistries capable of brightening a surface 40, 40ⁿ. For example, one or more acid chemistries capable of brightening a surface 40, 40ⁿ may be provided after any residual cleaning composition 12, grime, and residue are removed from a surface. Suitable acid chemistries capable of brightening a surface 40, 40ⁿ include, but are not limited to, organic acids and inorganic acids, such as citric acid, tartaric acid, glycolic acid (or hydroxyacetic acid), lactic acid, acetic acid, phosphoric acid, dodecyl benzene sulfonic acid, . . . the like, or combinations thereof.

In aspects of embodiments, the one or more acid chemistries capable of brightening a surface 40, 40ⁿ may be present in the form of a solution. In such aspects of this embodiment, the active ingredient (e.g., an acidic component) may be diluted (e.g., using a compatible solvent such as water) to be present in an amount ranging from about 0.01 wt % to about 15 wt % based on a total weight of the solution. In this aspect of an embodiment, the one or more acid chemistries capable of brightening a surface 40, 40ⁿ may be diluted to an amount ranging from about 0.01 wt % to about 10 wt % based on a total weight of the solution, while in another aspect in an amount ranging from about 0.01 wt % to about 5 wt % based on a total weight of the solution, and in yet another aspect in an amount ranging from about 0.01 wt % to about 2 wt % based on a total weight of the solution. Optionally, the dilute solution of the one or more acid chemistries capable of brightening a surface 40, 40ⁿ may include one or more buffers 32, 32ⁿ. In this other aspect of embodiments, the one or more buffers 32, 32ⁿ may range up to about 15 wt % based on a total weight of the solution, while in another aspect may range up to about 10 wt % based on a total weight of the solution, and in yet another aspect may range up to about 5 wt % based on a total weight of the solution.

Commercially available acid chemistries capable of brightening a surface 40, 40ⁿ suitable for use in the present invention include, but are not limited to, one or more acid chemistries capable of brightening a surface 40, 40ⁿ sold under the trade designation citric acid, tartaric acid, glycolic acid (or hydroxyacetic acid), lactic acid, acetic acid, phosphoric acid, dodecyl benzene sulfonic acid, . . . the like, available from DSM Nutritional Products, Inc. (Parsippany, N.J.), Gadot Bio-Chem USA, Ltd. (Buffalo Grove, Ill.), Jungbunzlauer Inc. (Newton Centre, Mass.), Cargill Flavor Systems (Cincinnati, Ohio), Pilot Chemical Co. (Cincinnati, Ohio), and Stepan Co. (Northfield, Ill.).

D. One or More Hydrotropes 44, 44ⁿ

According to aspects of embodiments and embodiments of the present invention, the cleaning compositions 12 may also contain one or more hydrotropes 44, 44ⁿ. A hydrotrope is a material often used in a cleaner concentrate and/or cleaner to maintain a single phase neat or aqueous composition or solubilisate (liquid solution). Such hydrotrope may also be used in aspects of embodiments and/or embodiments of the present invention. Hydrotropy is a property that relates to the ability of a material to improve the solubility or miscibility of a substance in liquid phases in which the substance tends to be insoluble. Materials that provide hydrotropy are called hydrotropes and are used in relatively lower concentrations than the materials to be solubilized. A hydrotrope modifies a formulation to increase the solubility of an insoluble substance or creates micellar or mixed micellar structures resulting in a stable suspension of the insoluble substance. The hydrotropic mechanism is not thoroughly understood. Apparently either hydrogen bonding between primary solvent, in this case water, and the insoluble substance are improved by the hydrotrope or the hydrotrope creates a micellar structure around the insoluble substance to maintain the substance in a suspension/solution. According to aspects of embodiments of the present invention, the one or more hydrotropes 44, 44ⁿ are useful in maintaining the ingredients of cleaning compositions 12 in a uniform solution (e.g., solubilisate) both during manufacture and when dispersed at the use location. The one or more surfactants 20, 20ⁿ according to aspects of embodiments of the invention alone or when combined with a one or more chelants 42, 42ⁿ, may be partially incompatible with an aqueous solution and can undergo a phase change or phase separation during storage of the solution. The one or more hydrotropes 44, 44ⁿ maintains a single phase solution (e.g., solubilisate) having the ingredients uniformly distributed throughout cleaning compositions 12 in an aqueous or non-aqueous form.

As to an amount of one or more hydrotropes 44, 44ⁿ, in one aspect it may be from about 0 wt % to about 20 wt %, based on the total weight of the cleaning compositions 12. In other aspects the one or more hydrotropes 44, 44ⁿ may be from about 1 wt % to about 9 wt % based on the total weight of the cleaning compositions 12. In yet other aspects the one or more hydrotropes 44, 44ⁿ may be from about 2 wt % to about 7 wt % based on the total weight of the cleaning compositions 12.

Hydrotropes exhibit hydrotropic properties in a broad spectrum of chemical molecule types. Hydrotropes generally include ether compounds, alcohol compounds, anionic surfactants, cationic surfactants, . . . the like, or combinations thereof. One hydrotrope usable according to aspects of embodiments of the invention include aromatic sulfonic acid, sulfonated hydrotropes such as C₁-C₅ substituted benzene sulfonic acid, naphthalene sulfonic acid, . . . the like, or combinations thereof. Examples of such a hydrotrope are xylene sulfonic acid, toluene sulfonic acid, naphthalene sulfonic acid, salts of xylene sulfonic acid (e.g., xylenesulfonic acid, sodium salt; xylenesulfonic acid, ammonium salt; xylenesulfonic acid, calcium salt; and/or xylenesulfonic acid, potassium salt; cumenesulfonic acid, sodium salt; and/or cumenesulfonic acid, ammonium salt), salts of toluene sulfonic acid (e.g., toluenesulfonic acid, sodium salt; and/or toluenesulfonic acid, potassium salt), salts of naphthalene sulfonic acid, . . . the like, or combinations thereof.

Also useful are the higher glycols, polyglycols, polyoxides, glycol ethers, propylene glycol ethers, . . . the like, or combinations thereof. Suitable commercially available biodegradable hydrotropic surfactants include dipropionates such as, but not limited to, MIRATAINE® H2C HA disodium lauriminodipropionate available from Rhodia Novecare (Cranbury, N.J.). Additional useful hydrotropes include the free acids, alkali metal salts of sulfonated alkylaryls such as alkylated diphenyloxide sulfonates, toluene, xylene, cumene and phenol or phenol ether sulfonates or alkoxylated diphenyl oxide disulfonates (DOWFAX® materials); alkyl and dialkyl naphthalene sulfonates, alkoxylated derivatives, . . . the like, or combinations thereof.

A number of commercially available one or more hydrotropes 44, 44ⁿ may be suitable for use in aspects of embodiments and/or embodiments of the present invention. Commercially available hydrotropes may be obtained from a variety of vendors including, but not limited to, Mason Chemical Company (Arlington Heights, Ill.), and Nease Corporate (Cincinnati, Ohio. For example, suitable commercially available hydrotropes include, but are not limited to, NAXONATE® 4L sodium xylene sulfonate, NAXONATE® 4LS sodium xylene sulfonate, NAXONATE® 4LOF sodium xylene sulfonate, NAXONATE® SX sodium xylene sulfonate, NAXONATE® 4AX ammonium xylene sulfonate, NAXONATE® 40SC sodium cumene sulfonate, NAXONATE® 45SC sodium cumene sulfonate, NAXONATE® SC sodium cumene sulfonate, NAXONATE® 4ST sodium toluene sulfonate, NAXONATE® ST sodium toluene sulfonate, and NAXONATE® 4KT potassium toluene sulfonate available from Nease Corporate (Cincinnati, Ohio).

E. Other Additives

According to aspects of embodiments and embodiments of the present invention, cleaning compositions 12 may contain one or more additives to provide a desired characteristic to the solution. Suitable additives include, but are not limited to, dyes, pigments, perfumes, preservatives, corrosion inhibitors, . . . the like, or combinations thereof. In an aspect of one embodiment, the cleaning composition 12 comprises one or more dyes to provide a desirable color.

Typically, additives, such as those mentioned above, are each individually present in an amount of less than about 2 wt % based on a total weight of the cleaning composition 12. In aspects of embodiments, each additive, when present, is individually present in an amount ranging from about greater than zero (≧0) to about 0.5 wt % based on a total weight of the cleaning composition 12.

A number of commercially available additives may be used in the present invention. Commercially available dyes suitable for use in the present invention include, but are not limited to, Yellow Dye FD&C#5 available from Pylam Products (Tempe, Ariz.); Blue Pylaklor LX 10092 available from Pylam Products (Tempe, Ariz.); Resorcine Brown 5GM available from Pylam Products (Tempe, Ariz.); and Acid Red #1 available from Keystone Aniline Corporation (Inman, S.C.). Commercially available perfumes suitable for use in the present invention include, but are not limited to, perfume SZ-6929 (Apple) available from J. E. Sozio, Inc. (Edison, N.J.); Orange SZ-40173 available from J. E. Sozio, Inc. (Edison, N.J.); and MF 3773 (lemon) available from Mane, USA (Wayne, N.J.). Commercially available preservatives suitable for use in the present invention include, but are not limited to, the family of preservatives sold under the trade designation UCARCIDE™, available from the Dow Chemical Company (Midland, Mich.), such as UCARCIDE™ 250 preservative and the family of preservatives sold under the trade designation KATHON™, available from Rohm and Haas Consumer and Industrial Specialties (Glen Allen, Va.), such as KATHON™ CG preservative.

F. Some Nonlimiting Examples of Cleaning Compositions

TABLE I
Examples of Cleaning Compositions

| | Wt % |
|---|---|
| Composition Example 1 | |
| Potassium carbonate, 47% | ~34 |
| (i.e., 47 wt % K₂CO₃ in water) | |
| Water | ~12 |
| Glycerine, 99.5% | ~49 |
| Coconut-based soap solution, 30% | ~6 |
| (i.e., 30 wt % solids) | |
| Dye | ~0.001 |
| Dow Antifoam Emulsion | ~0.0001 |
| (polydimethylsiloxane emulsion) | |
| Composition Example 2 | |
| Water | ~33 |
| Polypropylene Glycol | ~7 |
| Polyether siloxane surfactant | ~7 |
| Glycerine | ~50 |
| Citric acid, 50% | ~3 |
| (i.e., 50 wt % Citric acid in water) | |
| Composition Example 3 | |
| Water | ~38 |
| Linear dodecylbenzenesulfonic acid | ~4 |
| Citric acid, 50% | ~3 |
| (i.e., 50 wt % in water) | |
| Tartaric acid | ~0.3 |
| Hydroxyacetic acid, 70% | ~1 |
| (i.e., 70 wt % in water) | |
| Triethanolamine | ~0.5 |
| Sodium hydroxide, 50% | ~1.6 |
| (i.e., 50 wt % in water) | |
| Ethoxylated alcohol C10-12, 6 mole | ~1 |
| Propylene glycol | ~0.2 |
| Sodium xylene sulfonate, 40% | 0.6 |
| (i.e., 40 wt % in water) | |
| Glycerine | ~50 |
| Fragrance | ~0.03 |
| Dye | ~0.0003 |
| Composition Example 4 | |
| Water | ~63 |
| Citric acid, 50% | ~20 |
| (i.e., 50 wt % in water) | |
| Hydroxyacetic acid, 70% | ~5 |
| (i.e., 70 wt % in water) | |
| Alcohol, C8-C10, ethoxylated, | ~1.5 |
| propoxylated | |
| Sodium dodecylbenzenesulfonic acid | ~1 |
| Sodium xylene sulfonate | ~10 |
| Composition Example 5 | |
| Water | ~31 |
| Glycerine | ~50 |
| Citric acid, 50% | ~9 |
| (i.e., 50 wt % in water) | |
| Hydroxyacetic acid, 70% | ~2 |
| (i.e., 70 wt % in water) | |
| Alcohol, C8-C10, ethoxylated, | ~0.7 |
| propoxylated | |
| Sodium dodecylbenzenesulfonic acid | ~1 |
| Sodium xylene sulfonate | ~5 |
| Composition Example 6 | |
| Water | ~79 |
| Citric acid, 50% | ~20 |
| (i.e., 50 wt % in water) | |
| Sodium dodecylbenzenesulfonic acid | ~1 |
| Composition Example 7 | |
| Water | ~64 |
| Citric acid, 50% | ~20 |
| Hydroxyacetic acid, 70% | ~5 |
| Alcohol, C8-C10, ethoxylated, | ~1 |
| propoxylated | |
| Sodium xylene sulfonate | ~10 |
| Composition Example 8 | |
| Water | ~92 |
| Hydroxyacetic, 70% | ~5 |
| (i.e., 70 wt % in water) | |
| Sodium dodecylbenzenesulfonic acid | ~3 |
| Composition Example 9 | |
| Water | ~89 |
| Hydroxyacetic, 70% | ~5 |
| (i.e., 70 wt % in water) | |
| Sodium dodecylbenzenesulfonic acid | ~6 |
| Composition Example 10 | |
| Potassium Carbonate, 47% | ~10 to ~35 |
| (i.e., 47 wt % in water) | |
| Water | ~10 to ~60 |
| Glycerine, 99.5% | ~35 to ~75 |
| (i.e., 99.5 wt % pure) | |
| Triethylene glycol | ~0 to ~75 |
| Coconut-based soap solution, 30% | ~0.5 to ~9 |
| (i.e., 30 wt % solids) | |
| Dye | ~0.0001 to ~0.01 |

### II. SUBSTRATE 14

Turning once again to the Figures, in yet other aspects of embodiments, the substrate 14 of the cleaning system may include a polymeric material. In some of these aspects, the polymeric material may be or include any one of a woven fabric, knit fabric, nonwoven fabric or sheet, extruded sheet, expanded-extruded sheet, . . . the like, or any combination of any two or more of the preceding. In other of these aspects, the nonwoven fabric may any one of spunbond, airlaid, wet-laid, carded, spunlaced, meltblown, needlepunched, hydroentangled, . . . the like, or any combination of any two or more of the preceding. In still other of these aspects, the polymeric material may be or include a natural fiber, a manufactured fiber, or a natural fiber and a manufactured fiber. In other aspects, the polymeric material may be or include any one of a polyacrylonitrile (PAN), carbon fiber, polyester, rayon, spandex, polyolefin (e.g., including polyethylene {e.g., including DYNEEMA® family of products from DSM Dyneema LLC, Stanley, N.C.; SPECTRA® family of products from Honeywell Specialty Materials, Morristown N.J.}), polystyrene, polyvinyl, polyester, polyamide including aromatic polyamide (e.g., including TWARON® family of products from Teijin Aramid BV, Arnhem, Netherlands; KEVLAR® family of products from E.I. du Pont de Nemours and Co. Wilmington, Del.; TECHNORA® family of products from Teijin Aramid BV, Arnhem, Netherlands; NOMEX® family of products from E.I. du Pont de Nemours and Co., Wilmington, Del.), phenolic, polyurethane (e.g., including ZYLON® family of products from Toyobo Co., LTD., Osaka, Japan), polyimide, polyanhydrides, polycarbonate, polyketone, polysulfone, fluoropolymer (e.g., including GORE™ expanded PTFE {ePTFE, see e.g., Michael Wikol et al., “Expanded Polytetrafluoroethylene Membranes and Their Applications” in Filtration and Purification in the Biopharmaceutical Industry, Second Edition, edited by Maik W. Jornitz and Theodore H. Meltzer, November 2007, Informa Healthcare USA, New York, N.Y. which is herein incorporated by reference} family of products from W. L. Gore & Associates, Inc., Newark, Del.), structural polysaccharide (e.g., including coir, cotton, flax, hemp, jute, manila, piña, raffia, ramie, sisal, a modified version of any of the preceding {e.g., a modified cellulose}, . . . the like, or any combination of any two or more of the preceding), a copolymer of any two or more of the preceding, a microfiber of any two or more of the preceding, a conjugate fiber of any two or more of the preceding, a blend of any two or more of the preceding, or any combination of any two or more of the preceding.

In still yet other aspects of embodiments relating to the substrate 14, the polymeric material may be selected from among polymeric materials having a variety of thermal properties including one of thermal decomposition temperature (Td), glass transition temperature (Tg), melting point temperature (Tm), or any combination of any two or more of the preceding.

To that end in aspects of embodiments of the present invention, the thermal decomposition temperature (Td) may be determined using thermogravimetric analysis (TGA). For analysis using TGA, a sample (e.g., about 10 to about 20 milligrams {mg} depending on the sample density) of a material is placed in a sample holder in the heating element of TGA such as a Model Q50 Thermogravimetric Analyzer made by TA Instruments (New Castle, Del.). The sample is heated from room temperature, which commonly ranges from about 18° C. (64° F.) to about 24° C. (75° F.), to a temperature of up to 1200° C. (2192° F.), depending on the material being evaluated, at a heating rate of 10° C. (50° F.) per minute. The sample is heated under a dynamic atmosphere of air with a flow of about 60 milliliters (mL) per minute while the balance shielded with an inert gas (e.g., nitrogen, argon, or helium as may be appropriate) with a flow of about 40 mL per minute. The crucible is continuously weighed during heating so that any decrease in weight can be detected. The resulting weight-change versus temperature curves for the tested material (i.e., plots of sample weight versus temperature) show a decomposition temperature (Td) in air. Reference may be made to ASTM Standard E1131, 2003, “Standard Test Method for Compositional Analysis by Thermogravimetry” ASTM International, West Conshohocken, Pa., www.astm.org (This test procedure details a technique incorporating thermogravimetry to determine the amount of medium volatile matter, highly volatile matter, combustible material, and ash content of materials. The temperature range of this test routine is room temperature to 1000° C. {1832° F.}. This test method may use either a reactive gas environment or an inert gas environment).

Also in aspects of embodiments of the present invention, glass transition temperature (Tg) may be determined using differential-scanning calorimetry (DSC). Further in aspects of embodiments of the present invention, melting point temperature (Tm) also may be determined using DSC. For analysis using DSC, a sample (e.g., about 5 to about 20 mg depending on the intensity of the transition {e.g., glass transition versus crystallization or melting}) of material is placed in the sample chamber of the heating/cooling block of a Model Q20 differential scanning calorimetry analyzer made by TA Instruments (New Castle, Del.). A Liquid Nitrogen Cooling Accessory, also made by TA Instruments, was attached to the Model Q20 differential scanning calorimeter. The sample can be heated from as low as −180° C. (−292° F.) to up to 725° C. (1337° F.), depending on the material being evaluated, then can be cooled to as low as −180° C. (−292° F.), then reheated again to up to 725° C. (1337° F.), at a heating and cooling rate of 10° C. (50° F.) per minute. The sample is heated under a dynamic atmosphere (e.g., air, nitrogen, argon, or helium as may be appropriate with a flow for air of about 50 mL, nitrogen of about 50 mL, helium of about 25 mL per minute). The resulting heat-flow versus temperature curves for the tested material (i.e., plots of heat-flow versus temperature) can show a variety of transitions and peaks over the temperature range. Slight transitions in lower temperature ranges can be associated with glass transition temperatures (Tg). Significant peaks in intermediate temperature ranges can be associate with crystallization temperature (Tc) while significant peaks in higher temperature ranges can be associate with melting temperature (Tm). Reference may be made to ASTM Standard D3418, 2003, “Standard Test Method for Transition Temperatures and Enthalpies of Fusion and Crystallization of Polymers by Differential Scanning Calorimetry” ASTM International, West Conshohocken, Pa., www.astm.org (This test procedure deals with the determination of transition enthalpies and temperature ranges of those transition enthalpies by differential scanning calorimetry {DSC}. The test procedure normal operating range is from 100° C. {212° F.} to 500° C. {932° F.}. As is apparent from the above description, it is possible to extend the temperature range, depending upon the specimen holders and instrumentation used.).

Table II includes a listing thermal decomposition temperature (Td), glass transition temperature (Tg), and melting point temperature (Tm) for a variety of polymer classes. In some aspects of one embodiment, a decomposition temperature (Td) may be a temperature of at least about 120° C. (248° F.), in an alternative aspect at least about 180° C. (356° F.), and in another alternative aspect at least about 450° C. (842° F.). In some aspects of another embodiment, a glass transition temperature (Tg) may be a temperature of at least about −120° C. (−184° F.), in an alternative aspect at least about −30° C. (−22° F.), in another alternative aspect at least about 150° C. (302° F.), and in still yet another alternative aspect at least about 260° C. (500° F.). In aspects of yet another embodiment, a melting point (Tm) may be a temperature of at least about 150° C. (302° F.), in an alternative aspect at least about 260° C. (500° F.), in another alternative aspect at least about 288° C. (550° F.), and in still yet another alternative aspect at least about 316° C. (600° F.)

TABLE II
Thermal Properties

| | Glass | Melting | Thermal |
|---|---|---|---|
| | Transition | Point | Decomposition |
| | Temperature | Temperature | Temperature |
| Polymer Classes | Tg [° C.] | Tm [° C.] | Td [° C.] |
| polyolefins | −143 . . . 286 | −63 . . . 425 | 130 . . . 800 |
| polystyrenes | −125 . . . 426 | −50 . . . 360 | 45 . . . 800 |
| polyvinyls | −225 . . . 440 | −55 . . . 400 | 25 . . . 850 |
| polyacrylics | −225 . . . 471 | −55 . . . 332 | −55 . . . 800 |
| polyhalo-olefins | −113 . . . 357 | 40 . . . 418 | 54 . . . 800 |
| polydienes | −135 . . . 375 | −41 . . . 418 | 50 . . . 500 |
| polyoxides | −155 . . . 480 | −47 . . . 585 | 23 . . . 1000 |
| polysulfides | −118 . . . 495 | −42 . . . 520 | 30 . . . 1000 |
| polyesters | −140 . . . 400 | −52 . . . 600 | 18 . . . 900 |
| polyamides | −140 . . . 427 | −47 . . . 600 | 50 . . . 900 |
| polyurethanes | −140 . . . 287 | 2 . . . 420 | 115 . . . 700 |
| polyureas | −77 . . . 292 | 2 . . . 370 | 200 . . . 700 |
| polyimides | −74 . . . 500 | −37 . . . 528 | 60 . . . 1000 |
| polyanhydrides | −120 . . . 302 | 30 . . . 410 | 130 . . . 450 |
| polycarbonates | −70 . . . 355 | 34 . . . 400 | 180 . . . 800 |
| polyimines | −105 . . . 495 | −30 . . . 580 | 30 . . . 1000 |
| polysiloxanes | −163 . . . 378 | −68 . . . 439 | 50 . . . 1000 |
| polyphosphazenes | −105 . . . 329 | −30 . . . 420 | 30 . . . 800 |
| polyketones | −139 . . . 470 | −47 . . . 585 | 30 . . . 850 |
| polysulfones | −56 . . . 490 | 24 . . . 458 | 107 . . . 900 |
| polyphenylenes | −65 . . . 352 | 13 . . . 550 | 175 . . . 900 |
| polytetrafluoroethylenes | −113 . . . 139 | 220 . . . 419 | 390 . . . 800 |

Aspects of embodiments of the present invention relate to the use of one or more nonwoven fabrics (also called bonded fabrics, formed fabrics, or engineered fabrics) in or as a substrate 14. To that end, those in the art will appreciate that nonwoven fabrics may be porous, textile-like materials, usually in flat sheet form, composed primarily or entirely of fibers assembled in webs. Nonwoven fabrics may be manufactured by processes, such as, spinbonding (alternatively: spin bonding), airlaying, wetlaying, carding, spinlacing, meltblowing, needlepunching, hydroentangling, . . . the like, or any combination of any two or more of the preceding. Thickness of nonwoven sheets may vary from about 25 micrometers (μm) to several centimeters (cm) and the basis weight may vary from about 10 gram per square meter (g/m²: also grams/square meter {gsm} where 1 ounce/square yard {osy}=34 gsm) to about 1000 gsm or more. In some aspects, the basis weight may vary from about 10 gsm to about 800 gsm or more; in other aspects, the basis weight may vary from about 20 gsm to about 600 gsm; in yet other aspects, the basis weight may vary from about 60 gsm to about 300 gsm; in still yet other aspects, the basis weight may vary from about 80 gsm to about 200 gsm; and in yet still other aspects, basis weight may vary from about 90 gsm to about 160 gsm. A nonwoven sheet may resemble paper or a woven or knitted fabric in appearance or may have a unique texture or pattern. It may be as compact and crisp as paper or supple and drapable as a conventional textile; it may be resilient or limp. Its tensile properties may be from barely self-sustaining or so high that it is impossible to tear, abrade, or damage the sheet by hand.

As already noted the fiber components, one or several types, may be natural or synthetic or both, from about 1 millimeter (mm) to about 3 mm long to endless. In some aspect, fiber sizes may range from about 0.1 to about 50 decitex (dtex: the weight in grams of 10,000 meters of yarn dtex {about 0.09 to about 45 denier [den: the weight in grams of 9,000 meters of yarn]} while in other aspects fiber sizes may range from about 1.5 to about 20 dtex (about 1.3 to about 18 den).

According to aspects of embodiments, nonwovens include fiber-web structures of fibers or filaments where the fundamental units may be arranged into a web and bonded in such a manner that the bond-to-bond distances may be greater than from about 50 to about 100 times a fiber diameter. In contrast to conventional textiles, the basic structure of nonwovens may be a web of fibers; thus the basic element may be the single fiber and the individual fibers may be arranged more or less randomly.

As noted there are many textiles and fabrics (e.g., woven fabric, knit fabric, nonwoven fabric or sheet, extruded sheet, expanded-extruded sheet, . . . the like, or any combination of any two or more of the preceding) suitable for use as substrate 14. In some of these aspects, high absorbency of a cleaning composition 12 and/or grime may be a significant property. To that end, such substrate 14 may provide a sponge-like action and the ability to wick up or absorb a cleaning composition 12 and/or grime or other liquids. The wicking and reservoir characteristics may be used in dispensing a cleaning composition 12. These materials may be hydrophilic if water or a water based liquid is to be absorbed.

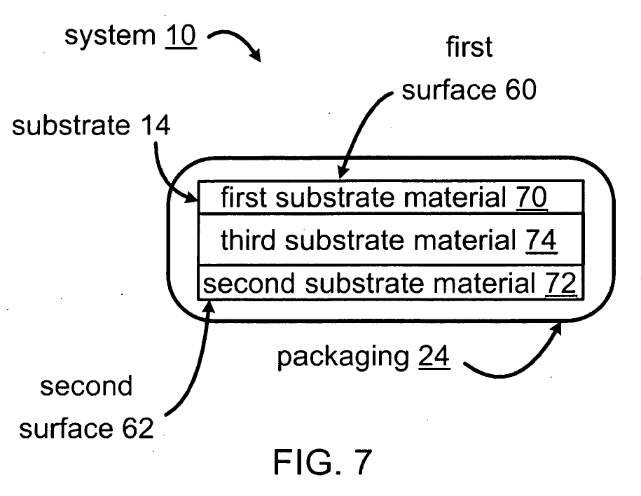

Aspect of embodiment and embodiments relate to disposable substrates 14. Disposable substrates 14 have the advantage that, after a single cleaning operation, they can simply be discarded. Disposable substrates 14 may exist as single-layer substrates, or as multi-layer substrates. The single-layer substrates may typically be made of a nonwoven material, and generally provide adequate cleaning composition 12 dispensing and grime removal capabilities. Multi-layered substrates, on the other hand, may be designed for cleaning composition 12 dispensing and grime removal and the absorption of large amounts of liquid into an absorbent layer. As depicted in FIG. 7, surface substrate materials 70, 72 (the layer that contacts the hard surface during the cleaning operation) of multi-layered cleaning substrates 14 may be either thin, apertured, plastic films (e.g., expanded PTFE) or high basis weight nonwovens.

Again as depicted in FIG. 7, substrate material 74 may comprises any material capable of at least dispensing cleaning composition 12 and, optionally, absorbing and retaining grime based fluid during use. The substrate material 74 may include a mono-layer, or a multi-layer. Typically, the substrate material 74 may be a nonwoven fibers. The fibers useful herein may be hydrophilic, hydrophobic or can be a combination of both hydrophilic and hydrophobic fibers. In aspects, the hydrophobic fibers or hydrophobic portions of fibers are lipophilic. As used herein, the term “hydrophilic” is used to refer to surfaces that are wettable by aqueous or polar fluids deposited thereon. Hydrophilicity and aqueous or polar fluid wettability are typically defined in terms of contact angle and the surface tension of the aqueous or polar fluids and solid surfaces involved. A surface is said to be wetted by a aqueous or polar fluid (e.g., hydrophilic) when either the contact angle between the aqueous or polar fluid and the surface is less than 90°, or when the aqueous or polar fluid tends to spread spontaneously across the surface, both conditions normally co-existing. Conversely, a surface is considered to be “hydrophobic” if the contact angle is greater than 90° and the aqueous or polar fluid does not spread spontaneously across the surface. As used herein, the term “lipophilic” is used to refer to surfaces that are wettable by fats, oils, lipids, or non-polar fluids deposited thereon. Lipophilicity and fats, oils, lipids, or non-polar fluid wettability are typically defined in terms of contact angle and the surface tension of the fats, oils, lipids, or non-polar fluids and solid surfaces involved. A surface is said to be wetted by a fats, oils, lipids, or non-polar fluid (e.g., lipophilic) when either the contact angle between the fats, oils, lipids, or non-polar fluid and the surface is less than 90°, or when the fats, oils, lipids, or non-polar fluid tends to spread spontaneously across the surface, both conditions normally co-existing. Conversely, a surface is considered to be “lipophobic” if the contact angle is greater than 90° and the fats, oils, lipids, or non-polar fluid does not spread spontaneously across the surface. This is discussed in detail in the American Chemical Society publication entitled “Contact Angle, Wettability and Adhesion”, edited by Robert F. Gould (Copyright 1964). The particular selection of hydrophilic or hydrophobic and/or lipophilic fibers may depend upon the cleaning composition 12 to be included in the substrate 14 and/or the grime created during the cleaning operation, for instance in different absorbent layers. That is, the nature of the fibers may be such that the cleaning substrate 14 exhibits the desired overall cleaning composition 12 dispensing and, optionally, grime fluid absorbency. Suitable hydrophilic fibers for use according to aspects of embodiments of the present invention may be selected from the hydrophilic polymers mentioned above. Suitable hydrophilic polymers may also be obtained by hydrophilizing hydrophobic polymers, such as surfactant-treated, silica-treated, and/or plasma-treated thermoplastic polymers derived from without limitation, for example, polyolefins such as polyethylene or polypropylene, polyacrylics, polyamides, polystyrenes, polyurethanes, . . . the like, or combinations thereof. The following US patents and patent publication provide some nonlimiting examples of treatments for hydrophilizing polymers: U.S. Pat. No. 5,069,926; U.S. Pat. No. 5,344,462; U.S. Pat. No. 5,403,453; U.S. Pat. No. 5,425,832; U.S. Pat. No. 6,093,491; U.S. Pat. No. 6,374,511; U.S. Pat. No. 6,479,595; U.S. Pat. No. 6,866,936; and US20030196275, the subject matter of each being herein incorporated by reference.

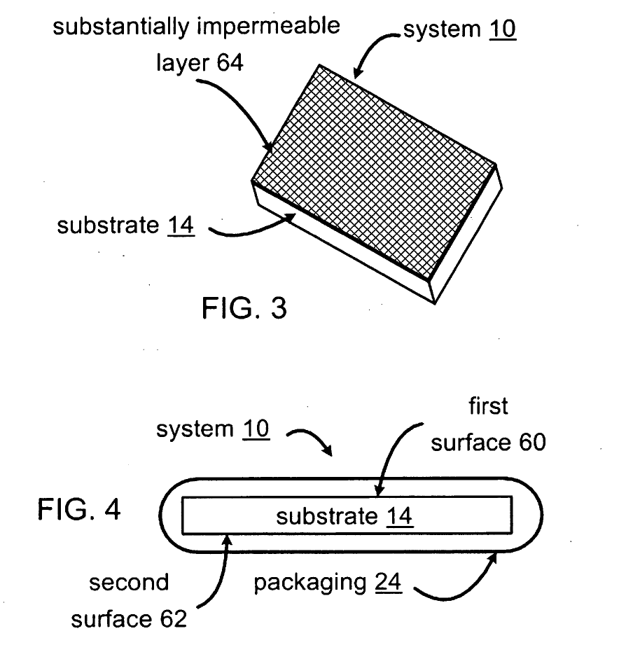

In still yet other aspects of embodiments relating to the cleaning system 10, the substrate 14 includes a length, a width, and a thickness. In some aspects, the length and width are substantially greater than the thickness, thereby defining a first substrate surface 60 and a second substrate surface 62. In some aspects, one of the first substrate surface 60 and the second substrate surface 62 is capable of conformably contacting the soiled surface 22′. As depicted in FIG. 3 in yet other aspects, one of the first substrate surface 60 and a second substrate surface 62 further comprises a layer substantially impermeable to the cleaning composition 12. In such other aspects, the substantially impermeable layer 64 may be or include one of a metallic foil, a polymeric film, a coating, or any combination of any two or more of the preceding. In alternative aspects, the first substrate surface 60 and the second substrate surface 62 may be permeable.

As depicted in FIG. 7 in still yet other aspects, the first substrate surface 60 includes a first substrate material 70, the second substrate surface 62 includes a second substrate material 72, and the substrate 14 further may include a third substrate material 74 between the first substrate material 70 and the second substrate material 72. In such other aspects, one or more of the first substrate material 70 and the second substrate material 72 may be adapted for delivering the cleaning composition 12 to the surface 22 upon contact with the surface 22, while the third substrate material 74 may be adapted for storing the cleaning composition 12 prior to contacting the substrate 14 with the surface 22. It will be appreciated that in such other aspects, one or more of the first substrate material 70 and the second substrate material 72 may be different from the third substrate material 74. Further, it will be appreciated that in such other aspects, the first substrate material 70, the second substrate material 72, and the third substrate material 74 may include or be substantially the same polymeric material.

### III. METHODS OF MAKING THE CLEANING SYSTEM 10

Making a cleaning system 10 includes providing a cleaning composition 12 and providing a substrate 14, both being selected for those being adapted to withstand a temperature up to the operating temperature of the surface 22 to be cleaned. Among suitable cleaning compositions 12 are those that include one or more solvents; optionally, one or more acidity sources 8 or one or more alkalinity sources 18, and one or more surfactants as has been discussed. Among suitable substrates 14 are those that include a material compatible with the cleaning composition as has been discussed. It will be appreciated that cleaning compositions 12 may impregnate the substrates 14.

Further, it will be appreciated that making cleaning compositions 12 may include enclosing the cleaning composition 12 and the substrate 14 in packaging 24. To that end, the cleaning composition 12 and the substrate 14 may be separately enclosed in packaging 24. In such case, a mechanism capable of effecting an impregnation 26 of the substrate 14 with the cleaning composition 12 may be added. Such mechanism for effecting an impregnation 26 of the substrate 14 with the cleaning composition 12 may be any that is adapted effecting an impregnation of the substrate 14 with the cleaning composition 12 prior to a contacting of the cleaning system 10 and a surface 22.

In an aspect of an embodiment, the method further includes providing a layer 64 to substrate 14. Such layer 64, which may be substantially impermeable to the cleaning composition 12, may be added to one of the first substrate surface 60 and a second substrate surface 62 so that the other of the first substrate surface 60 and a second substrate surface 62 is capable of conformably contacting the soiled surface 22′. It will be appreciated that such substantially impermeable layer 64 may include one of a metallic foil or a polymeric film and thus be provided to the substrate by compatible and/or appropriate method including without limitation, for example, gluing, bonding, fusing, mechanically interlocking, . . . the like, or combinations thereof.

The cleaning composition 12 of the present invention may be prepared using conventional mixing techniques. The components for forming the cleaning composition 12 may be combined with one or more solvents 16, 16ⁿ in any order at room temperature. Typically, cleaning composition 12 solutions are prepared by combining the components in the following order while mixing: one or more solvents 16, 16ⁿ, one or more viscosity control agents 34, 34ⁿ (when present), one or more surfactants 20, 20ⁿ, one or more alkalinity sources 18, 18ⁿ (when present) or one or more acidity sources 8, 8ⁿ (when present), and one or more other additives (e.g, when present, one or more builders 30, 30ⁿ, one or more foam-control agents 36, 36ⁿ, one or more hydrotopes 44, 44ⁿ).

In one aspect of an embodiment, a cleaning composition 12 is prepared using the following steps: (1) forming a premix by adding one or more solvents 16, 16ⁿ (e.g., water) to a first mix tank equipped with a stirrer after making sure that the first mix tank is clean; (2) stirring the one or more solvents 16, 16ⁿ at a speed sufficient to form a vortex in the one or more solvents 16, 16ⁿ; (3) adding one or more viscosity control agent 34, 34ⁿ to the one or more solvents 16, 16ⁿ while mixing; (4) letting the mixture stir for about 1 hour or until the mixture is uniform; (5) sampling the mixture to determine whether the one or more viscosity control agent 34, 34ⁿ has dissolved into the one or more solvents 16, 16ⁿ and continuing to mix for about 30 minutes if needed to completely dissolve the one or more solvents 16, 16ⁿ; (6) forming a main mixture by adding additional one or more solvents 16, 16ⁿ to a second mix tank equipped with a stirrer after making sure that the second mix tank is clean; (7) pumping the premix into the second mix tank; (8) adding one or more surfactants 20, 20ⁿ to the second mix tank; (9) adding one or more acidity sources 8, 8ⁿ or one or more alkalinity sources 18, 18ⁿ to the second mix tank; (10) adding dye to the second mix tank and mixing the mixture for about 15 minutes; and (11) sampling the mixture to test for desired mixture properties.

In a further desired embodiment of the present invention, a cleaning composition 12 is prepared using the following steps: (1) adding one or more solvents 16, 16ⁿ such as water to a mix tank equipped with a stirrer after making sure that the mix tank is clean; (2) stirring the water at a speed sufficient to form a vortex in the water; (3) adding additional one or more solvents 16, 16ⁿ, such as a mixture of triethylene glycol (TEG) and glycerine., to the water while mixing; (4) adding one or more viscosity control agents 34, 34ⁿ such as an acrylic polymer to the mixture; (5) optionally, adding one or more acidity sources 8, 8ⁿ or one or more alkalinity sources 18, 18ⁿ, such as potassium carbonate, to the mixture; (6) adding one or more surfactants 20, 20ⁿ, such as coconut soap surfactant, to the mixture; (7) adding dye to the mixture and stirring for about 15 minutes; and (8) sampling the mixture to test for desired mixture properties.

### VI. METHODS OF USING THE CLEANING SYSTEM

In operation as schematically depicted in FIG. 1 according to aspects of embodiments relating to using the cleaning system 10, a surface 22 to be cleaned may be maintained at any temperature up to the operating temperature of the surface 22 and the cleaning system 10 is contacted with a portion of the surface 22. For example, in the foodservice industry (e.g., encompasses those places, institutions, and companies responsible for any meal eaten away from home such as restaurants, caterers, and institutions {e.g., school cafeterias, hospital cafeterias, military cafeterias, . . . or the like}), a user may apply the cleaning system 12 onto a surface 22 of the grill or toaster while the grill or toaster surface is still hot, usually above 149° C. (300° F.) and up to 263° C. (505° F.) and more. Thus in some aspects, such temperature may be up to about 263° C. (505° F.) or more. In other aspects, a cleaning system 10 may be contacted with the soiled surface 22′ while the surface 22 is cooling from up to the operating temperature. In still yet other aspects, the method further may include communicating one or more acid chemistries capable of brightening a surface 40, 40ⁿ to the surface 22. In such aspects, applicants contemplate a variety of alternatives including, without limitation, the one or more acid chemistries capable of brightening a surface 40, 40ⁿ being communicated to the surface 22: (a) with the substrate 14 subsequent to the cleaning composition 12; and/or (b) via the substrate 14 to the surface 22 while the substrate 14 remains in communication with the surface 22 to augment the cleaning composition 12; and/or (c) directly after the substrate 14 has been removed; and/or (d) directly after removal of (i) the substrate 14 and any residue of the cleaning composition 12 and/or (ii) any residue resulting from an interaction of the cleaning composition 12 and the grime of the surface 22 and/or (iii) any residue of the grime.

To that end, cleaning systems 10 of the present invention may be used in a variety of applications including, but not limited to, household, commercial, institutional, and industrial applications. Suitable uses include, but are not limited to, as a hard surface and/or hot surface cleaner such as a food processing plant cleaner, food contact area cleaner, and rust remover. The cleaning systems 10 of the present invention are particularly suitable for use as cleaners for cooking surfaces and cookware, such as grill surfaces, toasters, fryers, ovens, hoods, rotisseries, and popcorn poppers, such as those commonly found in the foodservice industry.

One desired method of using the cleaning system 10 of the present invention is in the foodservice industry. For example in some cases, quick service restaurants (QSRs) desire a cleaning system 10, which may be used at high temperatures, typically as high as 263° C. (505° F.). In one method of the present invention, a cleaning system 10 is contacted with a surface 22 of a cooking surface, such as a grill or toaster surface, while the cooking surface is at a temperature of up to about 263° C. (505° F.), and usually from about 93° C. (200° F.) to about 263° C. (505° F.). The cleaning system 10 is spread across the surface 22. Typically, the cleaning system 10 remains on the surface 22 for a period of up to about 10 minutes or more, usually from about 0.5 to about 5 minutes. After removing the cleaning system 10, a user may rinse and/or wipe the surface 22 of the cooking apparatus with a squeegee or damp cloth, removing substantially all of the liquid cleaning composition and particulate material from the cooking surface. Optionally, the surface 22 of the cooking apparatus may be treated with a one or more acid chemistries capable of brightening a surface 40, 40ⁿ prior to or following a rinsing and/or wiping. When a cleaning composition 12 includes one or more alkalinity sources 18, 18ⁿ, it is desirable to provide the one or more acid chemistries capable of brightening a surface 40, 40ⁿ following a rinsing and/or wiping of a cooking surface. These procedures may be repeated as needed.

### V. EXAMPLES

### Example 1

A substrate is made from a sheet type material measuring about 8.5 inches wide by about 11 inches deep using a GORE™ ePTFE (W. L. Gore & Associates, Inc., Newark, Del.). The substrate is combined with a cleaning composition designated Hi-Temp Grill Cleaner (available from Kay Chemicals, Inc., Greensboro, N.C.) to make a cleaning system. The cleaning system is applied to the surface (made from steel) of a commercial griddle measuring about 24 inches wide by about 20 inches deep (Model H286-24GTH from Garland Commercial Industries, LLC (Freeland, Pa.). The surface is soiled with the grime and residue of grilled foods. The temperature of the surface is maintained at about the normal operating temperature of the griddle, namely about 177° C. (350° F.). The cleaning system is kept on the griddle surface for about 5 minutes (min). During this time a grill tool fitted with a no-scratch pad available from Kay Chemical Company (Greensboro, N.C.) is readied for use after the removal of the cleaning system. Surprisingly and unexpectedly, after the cleaning system is removed, it is observed that there is no need to use the grill tool fitted with a no-scratch pad for cleaning the griddle surface. Also surprisingly and unexpectedly, it is observed that grime and residue of the griddle surface adheres to the cleaning system and is thus removed upon its removal from the griddle surface. Likewise, any remaining residue is removed by rinsing the surface and using the griddle squeegee.

### Example 2

A first substrate is made from a sheet type material measuring about 8.5 inches wide by about 11 inches deep using a GORE™ ePTFE (W. L. Gore & Associates, Inc., Newark, Del.). A second substrate is made from a nonwoven material measuring about 8.5 inches wide by about 11 inches deep using a CHICOPEE™ soft cloth nonwoven towel (Polymer Group, Inc. Charlotte, N.C.). Each substrate is combined with a cleaning composition designated Hi-Temp Grill Cleaner (available from Kay Chemicals, Inc., Greensboro, N.C.) to make a first cleaning system and a second cleaning system. The first and second cleaning systems are applied to the surface (made from steel) of a commercial griddle measuring about 24 inches wide by about 20 inches deep (Model H286-24GTH from Garland Commercial Industries, LLC (Freeland, Pa.). Half of each cleaning system is then covered using commercially available aluminum foil. The surface is soiled with the grime and residue of grilled foods. The temperature of the surface is maintained at about the normal operating temperature of the griddle, namely about 177° C. (350° F.). The first and second cleaning systems are kept on the griddle surface for about 5 minutes (min). After the cleaning systems, including the aluminum foil, are removed and it is observed that there was no need to use the griddle pad with the griddle pad holder and, thus, the griddle screen to complete a cleaning of the griddle surface. Also, it is observed that grime and residue of the griddle surface adheres to the cleaning systems and is thus removed upon their removal from the griddle surface. Likewise, any remaining residue is removed by rinsing the surface and using the griddle squeegee. Further, it is observed that grime and residue of the griddle surface adhered to the cleaning system and is thus removed upon its removal from the grill. Moreover, a comparison of the areas of the griddle that contacted with the first and second cleaning system in combination with the aluminum foil shows that these areas are cleaner than the areas that solely contacted with the first and second cleaning system. As between the first cleaning system made using the GORE™ ePTFE and second cleaning system made using the CHICOPEE™ nonwoven towel, the area contacted with second cleaning system is cleaner than the area contacted with first cleaning system.

### Example 3

Two substrates are made from a sheet type material measuring about 8.5 inches wide by about 11 inches deep using a GORE™ ePTFE (W. L. Gore & Associates, Inc., Newark, Del.). The two substrates are combined with a cleaning composition designated Hi-Temp Grill Cleaner (available from Kay Chemicals, Inc., Greensboro, N.C.) to make two cleaning systems. The two cleaning systems are applied to the surface (made from steel) of a commercial griddle measuring about 24 inches wide by about 20 inches deep (Model H286-24GTH from Garland Commercial Industries, LLC (Freeland, Pa.). One of the two cleaning systems is then covered using commercially available aluminum foil. The surface is soiled with the grime and residue of grilled foods. The temperature of the surface is maintained at about the normal operating temperature of the griddle, namely about 177° C. (350° F.). The two cleaning systems are kept on the griddle surface for about 5 minutes (min) after the cleaning systems, including the aluminum foil, are removed and it is observed that there is no need to use the griddle pad with the griddle pad holder and, thus, the griddle screen to complete a cleaning the griddle surface. Also, it is observed that grime and residue of the griddle surface adhered to the cleaning systems and is thus removed upon their removal from the griddle surface. Likewise, any remaining residue is removed by rinsing the surface and using the griddle squeegee. Further, it is observed that grime and residue of the griddle surface adheres to the cleaning system and is thus removed upon its removal from the grill. Moreover, a comparison of the areas of the griddle that contacted with the cleaning system in combination with the aluminum foil shows that these areas are cleaner than the areas that solely contacted with the cleaning system.

### Example 4

Two substrates are made from a sheet type material measuring about 8.5 inches wide by about 11 inches deep using a GORE™ ePTFE (W. L. Gore & Associates, Inc., Newark, Del.). The two substrates are combined with a cleaning composition designated Hi-Temp Grill Cleaner (available from Kay Chemicals, Inc., Greensboro, N.C.) to make two cleaning systems. The two cleaning systems are applied to the surface (made from steel) of a commercial griddle measuring about 24 inches wide by about 20 inches deep (Model H286-24GTH from Garland Commercial Industries, LLC (Freeland, Pa.). Both cleaning systems are then covered using commercially available aluminum foil. The surface is soiled with the grime and residue of grilled foods. The temperature of the surface is maintained at about the normal operating temperature of the griddle, namely about 177° C. (350° F.). The two cleaning systems are kept on the griddle surface for about 5 minutes (min) after the cleaning systems, including the aluminum foil, are removed and it is observed that there is no need to use the griddle pad with the griddle pad holder and, thus, the griddle screen to complete a cleaning the griddle surface. Also, it is observed that grime and residue of the griddle surface adhered to the cleaning systems and is thus removed upon their removal from the griddle surface. Likewise, any remaining residue is removed by rinsing the surface and using the griddle squeegee. One side of the griddle is then treated with a weak acid formulation (i.e., one or more acid chemistries capable of brightening a surface 40, 40ⁿ), The half treated with the weak acid formulation is brighter than the untreated half.

### Examples 5-19

A number of substrates are made using one of a GORE™ ePTFE (W. L. Gore & Associates, Inc., Newark, Del.); Polyester 125, Nylon 125 (Texel—a division of ADS Inc., Saint-Elzear-de-Beauce, Quebec, Canada); Polyester 110, 125; Nylon 110, 125 (Texel—a division of ADS Inc., Saint-Elzear-de-Beauce, Quebec, Canada and Polyester 150, 160, Nylon 150 (Texel—a division of ADS Inc., Saint-Elzear-de-Beauce, Quebec, Canada As shown in Table III, the substrates are combined with a cleaning composition to make cleaning systems. Also as shown in Table III, the cleaning systems are applied to a test surface of one of a commercial stainless steel griddle measuring about 24 inches wide by about 20 inches deep (Model H286-24GTH from Garland Commercial Industries, LLC, Freeland, Pa.); commercial stainless steel clam-shell griddle measuring about 36 inches wide by about 24 inches deep (Model No. Model QS23 manufactured by Taylor Company, A Division of Carrier Commercial Refrigeration, Inc., Rockton, Ill.); commercial stainless steel clam-shell type griddle measuring about 24 inches wide by about 20 inches deep sold under the Garland brand by Enodis USA New Port Richey, Fla.); and 6 inches wide×3 inches deep×0.032 inch thick CRS SAE 1008/1010 steel panel obtained form Q-Lab Corp., Cleveland, Ohio. The surface of the commercial stainless steel griddles is soiled with the grime and residue of food soils. The surface of the steel panels is soiled with the grime and residue of trough grease obtained from a quick service restaurant that is evenly applied to the steel panels using a commercially available paint roller while heating the panels using a hot plate at about ˜204° C. (˜400° F.) to create a consistent soil across the surface of the panels. Table III show the temperature of the surface when cleaning systems are applied to the test surface. The cleaning systems and the test surfaces are kept in contact for about 5 minutes (min). After the cleaning systems and test surfaces are separated, the stability of the components of the substrate and the effectiveness of the cleaning system are noted.

In interpreting these data, it should be understood that the soil removal rating is graded on a scale from 1 to 4, where a rating of:
1 is given for a cleaning system and/or cleaning composition that removes up to about 25 percent of the test soil from the test substrate under “self-working” (without manual scrubbing) conditions;
2 is given for a cleaning system and/or cleaning composition that removes greater than about 25 percent and up to about 50 percent of the test soil from the test substrate under “self-working” (without manual scrubbing) conditions;
3 is given for a cleaning system and/or cleaning composition that removes greater than about 50 percent and up to about 75 percent of the test soil from the test substrate under “self-working” (without manual scrubbing) conditions; and
4 is given for a cleaning system and/or cleaning composition that removes greater than about 75 percent and up to 100 percent of the test soil from the test substrate under “self-working” (without manual scrubbing) conditions.

TABLE III
Tabulation of Tests

| | | | | | Substrate 14 | | |
|---|---|---|---|---|---|---|---|
| | Cleaning | | | Surface | Substrate Component | | Grade |
| | Composition | | Test Surface | Temperature | Wt (gsm) | Component | (1 = Poor, |
| | Ingredient(s) | Wt % | [Source] | ° C. (° F.) | [Source] | Stability | 4 = Excellent) |
| Comparative | Water | 57.15 | 24″ wide × 20″ | Not Determined | None | NA | 2 |
| Example | Sodium Xylene | 9.00 | deep, Garland | | | | |
| | Sulfonate | | commercial | | | | |
| | (40%) | | stainless steel | | | | |
| | Citric Acid 50% | 18.00 | griddle [Model | | | | |
| | Glycolic Acid | 4.5 | H286-24GTH] | | | | |
| | 70% | | | | | | |
| | TRITON ™ | 3.0 | | | | | |
| | DF-16 | | | | | | |
| | surfactant | | | | | | |
| | PLURIOL ® P | 8.35 | | | | | |
| | 425 surfactant | | | | | | |
| Example 5 | Water | 33.0 | 24″ wide × 20″ | Not Determined | Needlepunched Polyester Weight 125, | Polyester degraded; | 1 |
| | Glycerine | 50.0 | deep, Garland | | Needlepunched Nylon Weight 125 | Nylon ok | |
| | PLURIOL ® | 7.0 | commercial | | [Texel- a division of ADS Inc., | | |
| | E600 | | stainless steel | | Saint-Elzear-de-Beauce, Quebec, | | |
| | TEGAPON ® | 7.0 | griddle [Model | | Canada] | | |
| | 8843 | | H286-24GTH] | | | | |
| Example 6 | Citric Acid | 3.0 | 24″ wide × 20″ | Not Determined | GORE ™ ePTFE | Ok | 1 |
| | | | deep, Garland | | [W. L. Gore & Associates, Inc., | | |
| | | | commercial | | Newark, DE] | | |
| | | | stainless steel | | | | |
| | | | griddle [Model | | | | |
| | | | H286-24GTH] | | | | |
| Example 7 | K₂CO₃47% | 33.72 | 24″ wide × 20″ | 165-182(330-360) | Needlepunched Polyester Weight 125, | Polyester ok; | 3 |
| | Water | 11.92 | deep, Garland | | Needlepunched Nylon Weight 125 | Nylon ok | |
| | Glycerine | 48.53 | commercial | | [Texel- a division of ADS Inc., | | |
| | Coco Soap | 5.83 | stainless steel | | Saint-Elzear-de-Beauce, Quebec, | | |
| | | | griddle [Model | | Canada] | | |
| | | | H286-24GTH] | | | | |
| Example 8 | | | 36″ wide × 24″ | Bottom: 191(375); | Needlepunched Polyester Weight 125, | Polyester degraded;Nylon ok | 3 |
| | | | deep Taylor | Top: 218(425) | Needlepunched Nylon Weight 125 | | |
| | | | commercial | | [Texel- a division of ADS Inc., | | |
| | | | stainless steel clam- | | Saint-Elzear-de-Beauce, Quebec, | | |
| | | | shell griddle | | Canada] | | |
| Example 9 | | | 24″ wide × 20″ | Not Determined | Needlepunched Polyester Weights | Polyester degraded; | 3 |
| | | | deep Garland | | 110, 125; Needlepunched | Nylon ok | |
| | | | commercial | | Nylon Weights 110, 125 | | |
| | | | stainless steel | | [Texel- a division of ADS Inc., | | |
| | | | clam-shell type | | Saint-Elzear-de-Beauce, Quebec, | | |
| | | | griddle | | Canada] | | |
| Example 10 | | | 6″ wide × 3″ deep × | 204(400) | Needlepunched Polyester Weight 125, | Polyester degraded; | 3 |
| | | | 0.032″ thick | | Needlepunched Nylon Weight 125 | Nylon ok | |
| | | | CRS SAE | | [Texel- a division of ADS Inc., | | |
| | | | 1008/1010 steel | | Saint-Elzear-de-Beauce, Quebec, | | |
| | | | panel | | Canada] | | |
| | | | [Q-Lab Corp., | | | | |
| | | | Cleveland, OH] | | | | |
| Example 11 | | | 24″ wide × 20″ | Not Determined | GORE ™ ePTFE | ePTFE ok | 3 |
| | | | deep, Garland | | [W. L. Gore & Associates, Inc., | | |
| | | | commercial | | Newark, DE] | | |
| | | | stainless steel | | | | |
| | | | griddle [Model | | | | |
| | | | H286-24GTH] | | | | |
| Example 12 | Water | 41.06 | 6″ wide × 3″ deep × | ~204(~400) | Needlepunched Polyester Weight 125, | Polyester degraded; | 1 |
| | Dodecyl | 11.21 | 0.032″ thick | | Needlepunched Nylon Weight 125 | Nylon degraded | |
| | Benzenesulfonic | | CRS SAE | | [Texel- a division of ADS Inc., | | |
| | Acid (DDBSA) | | 1008/1010 steel | | Saint-Elzear-de-Beauce, Quebec, | | |
| | Citric Acid 50% | 4.20 | panel | | Canada] | | |
| | Glycolic Acid | 2.31 | [Q-Lab Corp., | | | | |
| | Tartaric Acid | 0.83 | Cleveland, OH] | | | | |
| Example 13 | Triethanolamine −85 | 1.26 | 24″ wide × 20″ | 165-182(330-360) | None | NA | 1 |
| | (TEA 85%) | | deep, Garland | | | | |
| | NaOH 50% | 4.56 | commercial | | | | |
| | L12-6 | 2.23 | stainless steel | | | | |
| | Propylene | 0.57 | griddle [Model | | | | |
| | Glycol | | H286-24GTH] | | | | |
| Example 14 | Sodium Xylene | 1.68 | 24″ wide × 20″ | 165-182(330-360) | Needlepunched Polyester Weight 125, | Polyester degraded; | 2 |
| | Sulfonate | | deep, Garland | | Needlepunched Nylon Weight 125 | Nylon ok | |
| | (40%) | | commercial | | [Texel- a division of ADS Inc., | | |
| | Glycerine | 31.10 | stainless steel | | Saint-Elzear-de-Beauce, Quebec, | | |
| | | | griddle [Model | | Canada] | | |
| | | | H286-24GTH] | | | | |
| Example 15 | See Above | 85 | 6″ wide × 3″ deep × | 204(400) | None | NA | 1 |
| | Added Citric | 15 | 0.032″ thick | | | | |
| | Acid | | CRS SAE | | | | |
| | | | 1008/1010 steel | | | | |
| | | | panel | | | | |
| | | | [Q-Lab Corp., | | | | |
| | | | Cleveland, OH] | | | | |
| Example 16 | Hi-Temp Grill | 100 | 6″ wide × 3″ deep × | 204(400) | Needlepunched Polyester Weights | Polyester degraded; | 3 |
| | Cleaner | | 0.032″ thick | | 150, 160; Needlepunched | Nylon shrunk | |
| | (available from | | CRS SAE | | Nylon Weight 150 | | |
| | Kay Chemicals, | | 1008/1010 steel | | [Texel- a division of ADS Inc., | | |
| | Inc., | | panel | | Saint-Elzear-de-Beauce, Quebec, | | |
| | Greensboro, | | [Q-Lab Corp., | | Canada] | | |
| | N.C.) | | Cleveland, OH] | | | | |
| Example 17 | Glycerine | 85 | 6″ wide × 3″ deep × | 204(400) | Needlepunched Polyester Weights | Polyester degraded; | 1 |
| | Citric Acid 50% | 7.5 | 0.032″ thick | | 150, 160; Needlepunched | Nylon dissolved | |
| | Glycolic Acid | 7.5 | CRS SAE | | Nylon Weight 150 | | |
| | | | 1008/1010 steel | | [Texel- a division of ADS Inc., | | |
| | | | panel | | Saint-Elzear-de-Beauce, Quebec, | | |
| | | | [Q-Lab Corp., | | Canada] | | |
| | | | Cleveland, OH] | | | | |
| Example 18 | Hi-Temp Grill | 100 | 24″ wide × 20″ | Not Determined | GORE ™ ePTFE | ePTFE ok | 3 |
| | Cleaner | | deep, Garland | | [W. L. Gore & Associates, Inc., | polyester ok | |
| | (available from | | commercial | | Newark, DE] | ePTFE ok | |
| | Kay Chemicals, | | stainless steel | | Needlepunched Polyester Weight 95 | | |
| | Inc., | | griddle [Model | | [Texel- a division of ADS Inc., | | |
| | Greensboro, | | H286-24GTH | | Saint-Elzear-de-Beauce, Quebec, | | |
| | N.C.) | | | | Canada] | | |
| | | | | | GORE ™ ePTFE | | |
| | | | | | [W. L. Gore & Associates, Inc., | | |
| | | | | | Newark, DE] | | |
| Example 19 | Hi-Temp Grill | 100 | 24″ wide × 20″ | Not Determined | GORE ™ ePTFE | ePTFE ok | 3 |
| | Cleaner | | deep, Garland | | [W. L. Gore & Associates, Inc., | polyester ok | |
| | (available from | | commercial | | Newark, DE] | ePTFE ok | |
| | Kay Chemicals, | | stainless steel | | Needlepunched Polyester Weight 95 | | |
| | Inc., | | griddle [Model | | [Texel- a division of ADS Inc., | | |
| | Greensboro, | | H286-24GTH | | Saint-Elzear-de-Beauce, Quebec, | | |
| | N.C.) | | | | Canada] | | |
| | | | | | GORE ™ ePTFE | | |
| | | | | | [W. L. Gore & Associates, Inc., | | |
| | | | | | Newark, DE] | | |

Other than in the operating examples, or where otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the following specification and attached claims are approximations that may vary depending upon the desired properties sought to be obtained by an aspect of an embodiment and/or embodiments of the present invention. At the very least, and not as an attempt to limit the application of the doctrine of equivalents to the scope of the claims, each numerical parameter should be construed in light of the number of significant digits and ordinary rounding approaches.

Notwithstanding that the numerical ranges and parameters setting forth the broad scope of the invention are approximations, the numerical values set forth in the specific examples are reported as precisely as possible. Any numerical values, however, inherently contain certain errors necessarily resulting from the standard deviation found in their respective testing measurements.

While typical aspects of embodiment and/or embodiments have been set forth for the purpose of illustration, the foregoing description and the accompanying drawings should not be deemed to be a limitation on the scope of the invention. Accordingly, various modifications, adaptations, and alternatives may occur to one skilled in the art without departing from the spirit and scope of the present invention.
It should be understood that all such modifications and improvements have been deleted herein for the sake of conciseness and readability but are properly within the scope of the following claims.

### VI. ITEM NUMBERS

one or more acidity sources 8, 8ⁿ
cleaning system 10
cleaning composition 12
substrate 14
one or more solvents 16, 16ⁿ
one or more alkalinity sources 18, 18ⁿ
one or more surfactants 20, 20ⁿ
surface 22
soiled surface 22′
packaging 24
mechanism for effecting an impregnation 26
one or more builders 30, 30ⁿ
one or more buffers 32, 32ⁿ
one or more viscosity control agents 34, 34ⁿ
one or more foam-control agents 36, 36ⁿ
one or more acid chemistries capable of brightening a surface 40, 40ⁿ
one or more chelants (and/or sequestrants) 42, 42ⁿ
one or more hydrotropes 44, 44ⁿ
first substrate surface 60
second substrate surface 62
first substrate material 70
substantially impermeable layer 64
first substrate material 70
second substrate material 72 third substrate material 74

1. A cleaning system for cleaning a surface while maintaining the surface up to the operating temperature of the surface, the cleaning composition comprising:
A) a cleaning composition adapted to withstand a temperature up to operating temperature of the surface; the cleaning composition comprising:
i) one or more solvents,
ii) one or more surfactants, and
iii) a) one or more alkalinity sources or
b) one or more acidity sources; and
B) a substrate comprising a material and adapted to:
i) communicate the cleaning composition to the soiled surface,
ii) withstand a temperature up to the operating temperature at least during the communication of the cleaning composition, and
iii) withstand the cleaning composition at least during the communication of the cleaning composition.

2. The cleaning system according to claim 1, further comprising packaging adapted to enclose or protect the cleaning composition, the substrate, or the cleaning composition and substrate.

3. The cleaning system according to claim 2, wherein the packaging is adapted to separately enclose or protect the cleaning composition and separately enclose or protect the substrate.

4. The cleaning system according to claim 3, wherein the packaging further comprises a mechanism for effecting an impregnation of the substrate with an effective amount of cleaning composition for soil removal.

5. The cleaning system according to claim 1, wherein the cleaning composition comprises an effective amount for soil removal and at least partially impregnates the substrate.

6. The cleaning system according to claim 1, wherein the cleaning composition and the substrate are separate and further comprising a mechanism for effecting an at least partial impregnation of the substrate with an effective amount of cleaning composition for soil removal.

7. The cleaning system according to claim 1, wherein the operating temperature of the surface comprises up to about 263° C. (505° F.).

8. The cleaning system according to claim 1, wherein the one or more solvents comprise one of water, glycol, alcohol, glycol ether, ester, or combinations thereof.

9. The cleaning system according to claim 1, wherein the one or more acidity sources comprise one of a phosphoric acid, sulfamic acid, benzoic acid, formic acid (methanoic acid), acetic acid (ethanoic acid), propionic acid (propanoic acid), butyric acid (butanoic acid) valeric acid (pentanoic acid), caproic acid (hexanoic acid), enanthic acid (heptanoic acid), caprylic acid (octanoic acid), pelargonic acid (nonanoic acid) capric acid (decanoic acid), lauric acid (dodecanoic acid), myristic acid (tetradecanoic acid), palmitic acid (hexadecanoic acid), stearic acid (octadecanoic acid), oleic acid (cis-9-octadecenoic acid), linoleic acid (cis,cis-9,12-octadecadienoic acid), oxalic acid, malonic acid, succinic acid, maleic acid, fumaric acid, glutaric acid, adipic acid, pimelic acid, suberic acid, azelaic acid, sebacic acid, benzoic acid, carbonic acid, glycolic acid (hydroxyacetic acid), lactic acid, malic acid, tartaric acid, citric acid, hydrochloric acid, sulfuric acid, trichloroacetic acid, trifluoroacetic acid, linear alkylbenzene sulfonic acid (LAS), or combinations thereof.

10. The cleaning system according to claim 1, wherein the one or more surfactants comprise one of a dodecyl benzene sulfonic acid, salt of dodecyl benzene sulfonic acid, alkyl ether sulfate, salt of alkyl ether sulfate, olefin sulfonate, salt of olefin sulfonate, phosphate ester, fatty acid soap, sulfosuccinates, alkylaryl sulfonate, alkoxylated cationic ammonium surfactant, alkoxylate of an alkyl phenol, ethoxylate of an alkyl phenol, alkoxylate of an alcohol, ethoxylate of an alcohol, alkanolamide, alkyl polyglycocide, imidazoline derivative, betaine, amine oxide, or combinations thereof

11. The cleaning system according to claim 1, wherein the one or more alkalinity sources comprise one of ammonia (ammonium hydroxide), monoethanolamine, monopropanolamine, diethanolamine, dipropanolamine, triethanolamine, tripropanolamine, 2-amino-2-methyl-1-propanol (AMP), sodium hydroxide, potassium hydroxide, lithium hydroxide, sodium carbonate, potassium carbonate, sodium bicarbonate, potassium bicarbonate, sodium sesquicarbonate, potassium sesquicarbonate, sodium borate, potassium borate, sodium oxide, potassium oxide, or combinations thereof.

12. A method of using a substrate for cleaning a surface while maintaining the surface up to the operating temperature of the surface, the method comprising:
A) selecting a substrate comprising a polymeric material, the substrate being adapted to:
i) communicate a cleaning composition the soiled surface, the cleaning composition being adapted to withstand a temperature up to the operating temperature of the surface and being adapted to be capable of causing a selective removal of soil from the surface,
ii) withstand a temperature up to the operating temperature of the surface at least during the communication of the cleaning composition, and
iii) withstand the cleaning composition at least during the communication of cleaning composition; and
B) at least partially impregnating the substrate with the cleaning composition in an amount sufficient to be capable of causing the selective removal of soil from the surface; and
C) communicating the at least partially impregnated substrate with at least a portion of the soiled surface while maintaining the surface up to the operating temperature of the surface for a time sufficient to be capable of causing selective removal of soil from the surface without the necessity of mechanical action.

13. The method of using a substrate according to claim 12, wherein the polymeric material comprises any one of a woven fabric, knit fabric, nonwoven fabric, sheet, or any combination of any two or more of the preceding.

14. The method of using a substrate according to claim 12, wherein the polymeric material comprises natural fibers, manufactured fibers, or natural and manufactured fibers.

15. The method of using a substrate according to claim 12, wherein the polymeric material comprises a thermal decomposition temperature (Td) of at least about 120° C. (248° F.).

16. The method of using a substrate according to claim 12, wherein the polymeric material comprises a glass transition temperature (Tg) of at least about −120° C. (−184° F.).

17. The method of using a substrate according to claim 12, wherein the polymeric material comprises a melting point (Tm) of at least about 150° C. (302° F.).

18. The method of using a substrate according to claim 12, wherein the substrate comprises a length, a width, and a thickness, and the length and width are substantially greater than the thickness thereby defining a first substrate and a second substrate surface being opposite the first substrate surface, and the thickness being therebetween.

19. The method of using a substrate according to claim 18, wherein one of the first substrate surface and the second substrate surface is adapted for conformable communication with the soiled surface, and the other of the first substrate surface and a second substrate surface further comprises a layer substantially impermeable to the cleaning composition.

20. The method of using a substrate according to claim 19, wherein the substantially impermeable layer comprises one of a metal, a polymer, or a metal and polymer.

21. The method of using a substrate according to claim 18, wherein the first substrate surface and the second substrate surface are adapted to be permeable to the cleaning composition.

22. The method of using a substrate according to claim 18, wherein the first substrate surface comprises a first substrate material, the second substrate surface comprises a second substrate material, and further comprising a third substrate material between the first substrate material and the second substrate material.

23. The method of using a substrate according to claim 22, wherein one or both of the first substrate material and the second substrate material is adopted to communicate the cleaning composition to the surface substantially upon contact with the surface and wherein the third substrate material is adapted for storing the cleaning composition prior to contacting the substrate with the surface.

24. The method of using a substrate according to claim 22, wherein one or more of the first substrate material and the second substrate material are different from the third substrate material.

25. The method of using a substrate according to claim 22, wherein the first substrate material the second substrate material and the third substrate material comprise substantially the same polymeric material.

26. The method of using a substrate according to claim 13, wherein the polymeric material comprises any one of a polyacrylonitrile, carbon fiber, polyester, rayon, spandex, polyolefin, polystyrene, polyvinyl, polyester, polyamide including aromatic polyamide, phenolic, polyurethane, polyimide, polyanhydrides, polycarbonate, polyketone, polysulfone, fluoropolymer, an expanded PTFE, structural polysaccharide, a modified version of any of the preceding, a copolymer of any two or more of the preceding, a conjugate fiber of any two or more of the preceding, a blend of any two or more of the preceding, or any combination of any two or more of the preceding.

27. The method of using a substrate according to claim 12, wherein the substrate is further adapted for removing the mixture resulting from an interaction of the cleaning composition and the soil.

28. A method of cleaning a soiled surface while maintaining the surface up to the operating temperature of the surface, the method comprising the steps of:
A) contacting a cleaning system to the soiled surface while maintaining the surface up to the operating temperature of the surface, the cleaning system comprising:
i) a cleaning composition adapted to withstand a temperature up to the operating temperature of the surface; the cleaning composition comprising:
a) one or more solvents,
b) one or more surfactants, and
c) 1) one or more alkalinity sources or
2) one or more acidity sources; and
ii) a substrate comprising a material and adapted to:
a) communicate the cleaning composition to the soiled surface,
b) withstand a temperature up to the operating temperature at least during the communication of the cleaning composition, and
c) withstand the cleaning composition at least during the communication of the cleaning composition;
B) maintaining the substrate of the cleaning system in contact with the soiled surface for at least a time sufficient to be capable of causing the cleaning composition to interact with the soil of the soiled surface to create a mixture;
C) removing the substrate of cleaning system from the surface; and
D) removing any residual mixture from the surface thereby cleaning of the surface.

29. The method according to claim 28, wherein maintaining the surface up to the operating temperature of the surface comprises maintaining the surface up to about 263° C. (505° F.).

30. The method according to claim 28, wherein maintaining the substrate in contact with the soiled surface comprises maintaining the substrate in contact with the soiled surface while cooling the surface from up to the operating temperature.

31. The method according to claim 28, wherein the cleaning composition further comprises any one of one or more builders, one or more viscosity control agents, one or more foam control agents one or more hydrotropes, or any combination of any two or more of the preceding.

32. The method according to claim 28, further comprising providing one or more acid chemistries capable of brightening the surface to the surface after removing the substrate.

33. The method according to claim 32, wherein providing the one or more acid chemistries capable of brightening a surface to the surface comprises providing the one or more acid chemistries capable of brightening the surface after removing any residual mixture from the surface.

34. The method according to claim 28, wherein the polymeric material comprises one of a thermal decomposition temperature (Td) of at least about 120° C. (248° F.), a glass transition temperature (Tg) of at least about −120° C. (−184° F.), a melting point (Tm) of at least about 150° C. (302° F.), or combinations thereof.

35. The method according to claim 28, wherein the contacting the cleaning system to the soiled surface comprises conformably contacting the cleaning system to soiled surface.

36. The method according to claim 28, wherein:
A) the substrate comprises a length, a width, and a thickness, and the length and width are substantially greater than the thickness thereby defining a first substrate surface and a second substrate surface being opposite the first substrate surface, and a thickness being therebetween;
B) contacting the cleaning system to the soiled surface comprises communicating one of the first substrate surface and the second substrate surface with the soiled surface; and
C) the other of the first substrate surface and a second substrate surface further comprises a layer substantially impermeable to the cleaning composition.

37. The method according to claim 27, wherein the substantially impermeable layer comprises one of a metal, a polymer, or a metal and polymer.

38. The substrate according to claim 28, wherein the polymeric material comprises any one of a polyacrylonitrile, carbon fiber, polyester, rayon, spandex, polyolefin, polystyrene, polyvinyl, polyester, polyamide including aromatic polyamide, phenolic, polyurethane, polyimide, polyanhydrides, polycarbonate, polyketone, polysulfone, fluoropolymer, an expanded PTFE, structural polysaccharide, a modified version of any of the preceding, a copolymer of any two or more of the preceding, a conjugate fiber of any two or more of the preceding, a blend of any two or more of the preceding, or any combination of any two or more of the preceding.

39. A method of making a cleaning system for cleaning a soiled surface while maintaining the surface up to the operating temperature of the surface, the method comprising the steps of:
A) providing a cleaning composition adapted to withstand a temperature up to the operating temperature of the surface; the cleaning composition comprising:
i) one or more solvents,
ii) one or more surfactants, and
iii) a) one or more alkalinity sources or
b) one or more acidity sources;
B) providing a substrate comprising a material and adapted to:
i) communicate the cleaning composition to the soiled surface,
ii) withstand a temperature up to the operating temperature at least during the communication of the cleaning composition, and
iii) withstand the cleaning composition at least during the communication of the cleaning composition.

40. The method according to claim 39, wherein providing the cleaning composition comprises at least partially impregnating the substrate with an effective amount of cleaning composition for soil removal.

41. The method according to claim 39, further comprising enclosing the cleaning composition and the substrate in packaging.

42. The method according to claim 41, wherein the cleaning composition and the substrate are separately enclosed.

43. The method according to claim 41, further comprises providing a mechanism for effecting an at least partial impregnation of the substrate with an effective amount of cleaning composition for soil removal.

44. The cleaning system according to claim 39, wherein the cleaning composition and the substrate are separate and further comprising a mechanism for effecting an at least partial impregnation of the substrate with an effective amount of cleaning composition for soil removal.

45. The method according to claim 39, further comprising providing a mechanism for effecting an at least partial impregnation of the substrate with an effective amount of cleaning composition for soil removal so that the impregnation occurs prior to a contacting of the substrate to a soiled surface.

46. The method according to claim 39, wherein the operating temperature of the surface comprises up to about 263° C. (505° F.).

47. The method according to claim 39, wherein the cleaning composition further comprises any one of one or more builders, one or more viscosity control agents, one or more foam control agents, one or more hydrotropes, or any combination of any two or more of the preceding.

48. The method according to claim 39, wherein the material comprises a polymeric material comprising any one of a woven fabric, knit fabric, nonwoven fabric, sheet, or any combination of any two or more of the preceding.

49. The method according to claim 39, wherein the material comprises a polymeric material comprising natural fibers, manufactured fibers, or natural and manufactured fibers.

50. The method according to claim 39, wherein the polymeric material comprises a thermal decomposition temperature of at least about 120° C. (248° F.).

51. The method according to claim 39, wherein the polymeric material comprises a glass transition temperature (Tg) of at least about −120° C. (−184° F.).

52. The method according to claim 39, wherein the polymeric material comprises a melting point (Tm) of at least about 150° C. (302° F.).

53. The method according to claim 39, wherein the substrate comprises a length, a width, and a thickness, and the length and width are substantially greater than the thickness thereby defining a first substrate surface and a second substrate surface being opposite the first substrate surface, and the thickness being therebetween.

54. The method according to claim 39, further comprising providing a layer substantially impermeable to the cleaning composition to one of the first substrate surface and a second substrate surface so that the other of the first substrate surface and a second substrate surface is adapted for conformable communication with the soiled surface.

55. The method according to claim 54, wherein the substantially impermeable layer comprises one of a metal, a polymer, or a metal and polymer.

56. The method according to claim 54, wherein the first substrate surface and the second substrate surface are adapted to be permeable to the cleaning composition.

57. The method according to claim 39, wherein the polymeric material comprises any one of a polyacrylonitrile, carbon fiber, polyester, rayon, spandex, polyolefin, polystyrene, polyvinyl, polyester, polyamide including aromatic polyamide, phenolic, polyurethane, polyimide, polyanhydrides, polycarbonate, polyketone, polysulfone, fluoropolymer, an expanded PTFE, structural polysaccharide, a modified version of any of the preceding, a copolymer of any two or more of the preceding, a conjugate fiber of any two or more of the preceding, a blend of any two or more of the preceding, or any combination of any two or more of the preceding.
